(19) United States
(12) Patent Application Publication
(10) Pub. No.: US 2026/0206061 A1
(43) Pub. Date: Jul. 16, 2026

(54) RANDOM ACCESS MESSAGE BASED INDICATION OF USER EQUIPMENT CAPABILITIES

(71) Applicant: QUALCOMM Incorporated, San Diego, CA (US)

(72) Inventors: Jing LEI, San Diego, CA (US); Jing SUN, San Diego, CA (US); Krishna Kiran MUKKAVILLI, San Diego, CA (US)

(21) Appl. No.: 19/021,016

(22) Filed: Jan. 14, 2025

(51) Int. Cl. H04W 74/0833; H04W 72/0453

(52) U.S. Cl. CPC H04W 74/0833; H04W 72/0453

(57) ABSTRACT

Various aspects of the present disclosure generally relate to wireless communication. In some aspects, a user equipment (UE) may receive, from a network node via a first random access message as part of a random access procedure, an uplink resource grant associated with a first set of capabilities, wherein the UE is associated with a second set of capabilities. The UE may transmit, via a modified uplink resource grant, a second random access message in accordance with identifying that the uplink resource grant is incompatible with the second set of capabilities. Numerous other aspects are described.

### FIELD OF THE DISCLOSURE

Aspects of the present disclosure generally relate to wireless communication and specifically relate to techniques, apparatuses, and methods associated with random access message based indication of user equipment capabilities.

### BACKGROUND

Wireless communication systems are widely deployed to provide various services, which may involve carrying or supporting voice, text, other messaging, video, data, and/or other traffic. Typical wireless communication systems may employ multiple-access radio access technologies (RATs) capable of supporting communication among multiple wireless communication devices including user devices or other devices by sharing the available system resources (in some aspects, time domain resources, frequency domain resources, spatial domain resources, and/or device transmit power, among other examples). Such multiple-access RATs are supported by technological advancements that have been adopted in various telecommunication standards, which define common protocols that enable different wireless communication devices to communicate on a local, municipal, national, regional, or global level.

An example telecommunication standard is New Radio (NR). NR, which may also be referred to as 5G, is part of a continuous mobile broadband evolution promulgated by the Third Generation Partnership Project (3GPP). NR (and other RATs beyond NR) may be designed to better support enhanced mobile broadband (eMBB) access, Internet of things (IoT) networks or reduced capability device deployments, and ultra-reliable low latency communication (URLLC) applications. To support these verticals, NR systems may be designed to implement a modularized functional infrastructure, a disaggregated and service-based network architecture, network function virtualization, network slicing, multi-access edge computing, millimeter wave (mmWave) technologies including massive multiple-input multiple-output (MIMO), licensed and unlicensed spectrum access, non-terrestrial network (NTN) deployments, sidelink and other device-to-device direct communication technologies (in some aspects, cellular vehicle-to-everything (CV2X) communication), multiple-subscriber implementations, high-precision positioning, and/or radio frequency (RF) sensing, among other examples. As the demand for connectivity continues to increase, further improvements in NR may be implemented, and other RATs, such as 6G and beyond, may be introduced to enable new applications and facilitate new use cases.

Some wireless communications systems may support communications using multiple types of wireless communication devices, each associated with varying capabilities and use cases. In some aspects, wireless communication devices that are supported may include UEs categorized according to form factor and/or use case, such as wearable UEs, and/or vehicular UEs, and/or categorized according to complexity and capability, such as UEs that support eMBB access, IoT UEs and/or reduced capability (RedCap) UEs, UEs that support URLLC, and/or massive machine-type communication (mMTC) communications, among other examples. Some UEs may be classified according to different categories in association with different complexities and/or different capabilities. UEs in a first category may facilitate massive IoT, and may offer low complexity and/or cost relative to UEs in a second category. UEs in the second category may include mission-critical IoT devices, legacy UEs, baseline UEs, high-tier UEs, advanced UEs, full-capability UEs, and/or premium UEs that are capable of URLLC, eMBB, and/or precise positioning, among other examples. A third category of UEs may include RedCap UEs, which may be associated with mid-tier complexity and/or capability (in some aspects, a capability between that of the UEs of the first category and that of the UEs of the second category). RedCap UEs may bridge a gap between the capability and complexity of NB-IoT devices and/or eMTC UEs, and mission-critical IoT devices and/or premium UEs. RedCap UEs may include, in some aspects, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples. UEs in each category may use different resources and/or protocols to communicate with a network node according to a capability of the UE.

### SUMMARY

Some aspects described herein relate to an apparatus for wireless communication at a user equipment (UE). The apparatus may include one or more memories and one or more processors coupled to the one or more memories. The one or more processors may be, individually or collectively, configured to receive, from a network node via a first random access message as part of a random access procedure, an uplink resource grant associated with a first set of capabilities, wherein the UE is associated with a second set of capabilities. The one or more processors may be, individually or collectively, configured to transmit, via a modified uplink resource grant, a second random access message in accordance with identifying that the uplink resource grant is incompatible with the second set of capabilities.

Some aspects described herein relate to an apparatus for wireless communication at a network node. The apparatus may include one or more memories and one or more processors coupled to the one or more memories. The one or more processors may be, individually or collectively, configured to transmit, to a UE via a first random access message as part of a random access procedure, an uplink resource grant associated with a first set of UE capabilities, wherein the UE is associated with a second set of UE capabilities. The one or more processors may be, individually or collectively, configured to receive, via a modified uplink resource grant in accordance with the UE being associated with the second set of UE capabilities, a second random access message.

Some aspects described herein relate to a method of wireless communication performed by a UE. The method may include receiving, from a network node via a first random access message as part of a random access procedure, an uplink resource grant associated with a first set of capabilities, wherein the UE is associated with a second set of capabilities. The method may include transmitting, via a modified uplink resource grant, a second random access message in accordance with identifying that the uplink resource grant is incompatible with the second set of capabilities.

Some aspects described herein relate to a method of wireless communication performed by a network node. The method may include transmitting, to a UE via a first random access message as part of a random access procedure, an uplink resource grant associated with a first set of UE capabilities, wherein the UE is associated with a second set of UE capabilities. The method may include receiving, via a modified uplink resource grant in accordance with the UE being associated with the second set of UE capabilities, a second random access message.

Some aspects described herein relate to a non-transitory computer-readable medium that stores a set of instructions for wireless communication by a UE. The set of instructions, when executed by one or more processors of the UE, may cause the UE to receive, from a network node via a first random access message as part of a random access procedure, an uplink resource grant associated with a first set of capabilities, wherein the UE is associated with a second set of capabilities. The set of instructions, when executed by one or more processors of the UE, may cause the UE to transmit, via a modified uplink resource grant, a second random access message in accordance with identifying that the uplink resource grant is incompatible with the second set of capabilities.

Some aspects described herein relate to a non-transitory computer-readable medium that stores a set of instructions for wireless communication by a network node. The set of instructions, when executed by one or more processors of the network node, may cause the network node to transmit, to a UE via a first random access message as part of a random access procedure, an uplink resource grant associated with a first set of UE capabilities, wherein the UE is associated with a second set of UE capabilities. The set of instructions, when executed by one or more processors of the network node, may cause the network node to receive, via a modified uplink resource grant in accordance with the UE being associated with the second set of UE capabilities, a second random access message.

Some aspects described herein relate to an apparatus for wireless communication. The apparatus may include means for receiving, from a network node via a first random access message as part of a random access procedure, an uplink resource grant associated with a first set of capabilities, wherein the apparatus is associated with a second set of capabilities. The apparatus may include means for transmitting, via a modified uplink resource grant, a second random access message in accordance with identifying that the uplink resource grant is incompatible with the second set of capabilities.

Some aspects described herein relate to an apparatus for wireless communication. The apparatus may include means for transmitting, to a UE via a first random access message as part of a random access procedure, an uplink resource grant associated with a first set of UE capabilities, wherein the UE is associated with a second set of UE capabilities. The apparatus may include means for receiving, via a modified uplink resource grant in accordance with the UE being associated with the second set of UE capabilities, a second random access message.

Aspects of the present disclosure may generally be implemented by or as a method, apparatus, system, computer program product, non-transitory computer-readable medium, user equipment, base station, network node, network entity, wireless communication device, and/or processing system as substantially described with reference to, and as illustrated by, this specification and accompanying drawings.

The foregoing paragraphs of this section have broadly summarized some aspects of the present disclosure. These and additional aspects and associated advantages will be described hereinafter. The disclosed aspects may be used as a basis for modifying or designing other aspects for carrying out the same or similar purposes of the present disclosure. Such equivalent aspects do not depart from the scope of the appended claims. Characteristics of the aspects disclosed herein, both their organization and method of operation, together with associated advantages, will be better understood from the following description when considered in connection with the accompanying drawings.

### BRIEF DESCRIPTION OF THE DRAWINGS

The appended drawings illustrate some aspects of the present disclosure but are not limiting of the scope of the present disclosure because the description may enable other aspects. Each of the drawings is provided for purposes of illustration and description, and not as a definition of the limits of the claims. The same or similar reference numbers in different drawings may identify the same or similar elements.

FIG. 1 is a diagram illustrating an example of a wireless communication network, in accordance with the present disclosure.

FIG. 2 is a diagram illustrating an example disaggregated network node architecture, in accordance with the present disclosure.

FIG. 3 is a diagram illustrating an example including aspects of a two-step random access procedure and a four-step random access procedure that supports random access message based indication of user equipment (UE) capabilities, in accordance with the present disclosure.

FIG. 4 is a diagram illustrating an example of uplink frequency domain resource allocation (FDRA), in accordance with the present disclosure.

FIG. 5 is a diagram illustrating an example of time domain resource allocations, in accordance with the present disclosure.

FIGS. 6A through 6D are diagrams illustrating examples of frequency domain resource allocations (FDRAs) and/or time domain resource allocations (TDRAs), in accordance with the present disclosure.

FIG. 7 is a diagram of an example associated with random access message based indication of UE capabilities, in accordance with the present disclosure.

FIGS. 8A and 8B are diagrams illustrating examples of adapted FDRAs, in accordance with the present disclosure.

FIGS. 9A through 9D are diagrams illustrating examples of adapted FDRAs including one or more frequency hops, in accordance with the present disclosure.

FIG. 10 is a diagram illustrating an example of an adapted TDRA, in accordance with the present disclosure.

FIG. 11 is a diagram illustrating an example of an adapted TDRA, in accordance with the present disclosure.

FIG. 12 is a diagram illustrating an example process performed, in some aspects, at a UE or an apparatus of a UE, in accordance with the present disclosure.

FIG. 13 is a diagram illustrating an example process performed, in some aspects, at a network node or an apparatus of a network node, in accordance with the present disclosure.

FIG. 14 is a diagram of an example apparatus for wireless communication, in accordance with the present disclosure.

FIG. 15 is a diagram of an example apparatus for wireless communication, in accordance with the present disclosure.

### DETAILED DESCRIPTION

Various aspects of the present disclosure are described hereinafter with reference to the accompanying drawings. However, aspects of the present disclosure may be embodied in many different forms. The present disclosure is not to be construed as limited to any specific aspect illustrated by or described with reference to an accompanying drawing or otherwise presented in this disclosure. Rather, these aspects are provided so that this disclosure will be thorough and complete, and will fully convey the scope of the disclosure to those skilled in the art. One skilled in the art may appreciate that the scope of the disclosure is intended to cover any aspect of the disclosure disclosed herein, whether implemented independently of or in combination with any other aspect of the disclosure. In some aspects, an apparatus may be implemented, or a method may be practiced using various combinations or quantities of the aspects set forth herein. In addition, the scope of the disclosure is intended to cover an apparatus having, or a method that is practiced using, other structures and/or functionalities in addition to or other than the structures and/or functionalities with which various aspects of the disclosure set forth herein may be practiced. Any aspect of the disclosure disclosed herein may be embodied by one or more elements of a claim.

Several aspects of telecommunication systems will now be presented with reference to various methods, operations, apparatuses, and techniques. These methods, operations, apparatuses, and techniques will be described in the following detailed description and illustrated in the accompanying drawings by various blocks, modules, components, circuits, steps, processes, or algorithms (collectively referred to as “elements”). These elements may be implemented using hardware, software, or a combination of hardware and software. Whether such elements are implemented as hardware or software depends upon the particular application and design constraints imposed on the overall system.

A user equipment (UE) in some wireless communication systems (e.g., including in New Radio (NR) wireless telecommunications systems, and/or other radio access technologies (RATs) beyond NR) may perform one or more procedures for establishing a communications link with a network node that is operating as part of a wireless communication network. The UE may communicate a series of messages with the network node to establish access to the network. In some examples, establishing access to the network may be referred to as initial access. In some examples, the UE may perform a random access procedure to establish access to the wireless communication network via the network node (e.g., to establish a communication connection including an uplink connection and/or a downlink connection). In some examples, the random access procedure may also be referred to as a random access channel (RACH) procedure. In some examples, the UE may perform a RACH procedure including a four-step random access procedure or a two-step random access procedure.

As part of a four-step RACH procedure, the UE may transmit, and the network node may receive, a first message (msg1) via a physical random access channel (PRACH). The msg1 may include a PRACH preamble. The UE may receive, and the network node may transmit, a second message (msg2) via a physical downlink control channel (PDCCH) or via a physical downlink shared channel (PDSCH) based on transmitting the msg1. The msg2 may include a random access response (RAR) message that schedules a physical uplink shared channel (PUSCH) transmission by the UE. In some aspects, the msg2 may indicate and/or allocate uplink resources via which the UE may transmit a PUSCH message. The UE may transmit, and the network node may receive, a third message (msg3) including the PUSCH message, and/or the UE may transmit, and the network node may receive, the msg3 via the PUSCH resources. The UE may receive, and the network node may transmit, a fourth message (msg4) that includes a contention resolution message via the PDCCH or PDSCH. In some aspects, the UE may analyze the contention resolution message to identify whether the msg4 includes identification information (e.g., a radio network temporary identifier) that matches with the identification information of the UE (e.g., as opposed to identification information associated with a different UE). If the msg4 includes identification information associated with the UE, the UE may proceed with establishing the connection. Otherwise, the UE may restart the four-step RACH procedure, in some aspects, by retransmitting the msg1 and/or transmitting a second msg1.

As part of a two-step RACH procedure, the UE may transmit, and the network node may receive, a first message (msgA) including a PRACH preamble and including content similar to the content of the msg3 of the four-step RACH procedure, described above. The msgA transmission may include two transmissions. In some aspects, a first transmission may include a PRACH preamble via the PRACH, and may include timing information for uplink transmissions (e.g., timing information that enables the network node to set timing advance parameters). A second transmission may include the remaining content of the msgA. In some aspects, the msgA may additionally include a payload (e.g., a data payload) transmitted via the PUSCH that includes at least the msg3 contents. In some examples, the UE may transmit, and the network node may receive, a second message (msgB) including content similar to the contents of msg2 and/or msg4 of the four-step RACH procedure.

Some wireless communications systems may support communications using multiple types of wireless communication devices, each associated with varying capabilities and use cases. In some aspects, wireless communication devices that are supported may include UEs categorized according to form factor and/or use case, such as wearable UEs, and/or vehicular UEs, and/or categorized according to complexity and capability, such as UEs that support eMBB access, IoT UEs and/or reduced capability (RedCap) UEs, UEs that support URLLC, and/or massive machine-type communication (mMTC) communications, among other examples. Some UEs may be classified according to different categories in association with different complexities and/or different capabilities.

UEs in a first category may facilitate massive IoT, and may offer low complexity and/or cost relative to UEs in a second category. UEs in the second category may include mission-critical IoT devices, legacy UEs, baseline UEs, high-tier UEs, advanced UEs, full-capability UEs, and/or premium UEs that are capable of URLLC, eMBB, and/or precise positioning, among other examples. A third category of UEs may include RedCap UEs, which may be associated with mid-tier complexity and/or capability (in some aspects, a capability between that of the UEs of the first category and that of the UEs of the second category). RedCap UEs may bridge a gap between the capability and complexity of NB-IoT devices and/or eMTC UEs, and mission-critical IoT devices and/or premium UEs. RedCap UEs may include, in some aspects, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples. UEs in each category may use different resources and/or protocols to communicate with a network node according to a capability of the UE.

In some aspects, UEs having a reduced and/or different capability set (e.g., first or third category UEs), which are referred to herein as low-tier UEs, than some other UEs (e.g., second category UEs), which are referred to herein as high-tier UEs, may be associated with a reduced bandwidth reduction for baseband and/or radio frequency communications, an increased latency standard for baseband and/or radio frequency processing, and/or a half-duplex-only capability in some wireless communication systems for frequency division duplex communications and/or sub-band full duplex communications.

As a result, in the absence of a priori knowledge of UE capability, a network node may indicate frequency and/or time resource allocations during a RACH procedure that are incompatible with low-tier UEs. For example, one or more capabilities of the UE may be incompatible with the resource allocation, such as a bandwidth via which the low-tier UE is capable of communicating (e.g., the allocation may be wider than a bandwidth capability of the UE), one or more latency capabilities (e.g., an offset between communications may be too small for the low-tier to effectively tune between transmissions), and/or a method of communication available to the low-tier UE (e.g., half-duplex) (e.g., an offset between communications may be too small for the low-tier to effectively switch from receiving to transmitting). An incompatible resource allocation for an uplink random access message may result in the low-tier UE reinitiating the random access procedure, which may negatively affect latency and/or power consumption, and even still may not result in a successfully completed random access procedure because the network node may continue to indicate incompatible resource allocations in the absence of information indicating the capabilities and/or category of the low-tier UE. In some aspects, while msg3 indication of UE capability may be enabled, the network node may indicate resources for communicating the msg3 that may be incompatible with the UE capabilities. Additionally, a UE capability indication using a dedicated PRACH resource pool may reduce trunking efficiency.

Various aspects relate generally to enhancements for random access message (e.g., msg3) based early indication by low-tier UEs that may be associated with reduced capabilities. Some aspects more specifically relate to adaptation of incompatible frequency resource and/or time resource allocations. In some aspects, a UE, such as a low-tier UE, may perform a random access procedure with a network node, during which the UE may receive a random access message that includes and/or indicates an uplink resource allocation (e.g., a frequency resource allocation and/or a time resource allocation) for an uplink random access message that is incompatible with one or more capabilities of the UE. The UE may modify the uplink resource grant to adapt to the capabilities of the UE based on or otherwise in association with identifying that the uplink resource grant is incompatible with the capabilities of the UE. The UE may transmit, and the network node may receive, the uplink random access message via the modified and/or adapted uplink resource grant.

Some aspects relate to the UE puncturing allocated frequency resources and transmitting the uplink random access message via allocated frequency resources that overlap with an initial uplink (UL) bandwidth part (BWP) of the UE. In some such aspects, the UE may rate-match the uplink random access message across the overlapping frequency resources. Some aspects relate to the UE canceling allocated time resources and transmitting the uplink random access message via an abbreviated set of time resources to adapt to an insufficient timing offset between the downlink random access message and the uplink random access message and/or an insufficient timing offset between frequency hops of an adapted frequency resource allocation.

Particular aspects of the subject matter described in this disclosure can be implemented to realize one or more of the following potential advantages. In some examples, the described techniques can be used to enhance the coexistence of UEs having different capability levels and/or increase network capacity. In some aspects, by the UE transmitting the msg3 via the modified frequency resource allocation, the UE may conserve resources that would be otherwise expended attempting to reperform a random access procedure. By the UE transmitting the msg3 via the modified time resource allocation, the UE may decrease errors associated with receiving a message while processing a previous and/or retuning between frequency hops.

As described above, wireless communication systems may be deployed to provide various services, which may involve carrying or supporting voice, text, other messaging, video, data, and/or other traffic. Some wireless communications systems may employ multiple-access radio access technologies (RATs). The multiple-access RATs may be capable of supporting communication with multiple wireless communication devices by sharing the available system resources (in some aspects, time domain resources, frequency domain resources, spatial domain resources, and/or device transmit power, among other examples). Examples of such multiple-access RATs include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

Multiple-access RATs are supported by technological advancements that have been adopted in various telecommunication standards, which define common protocols that enable wireless communication devices to communicate on a local, municipal, enterprise, national, regional, or global level. In some aspects, 5G NR is part of a continuous mobile broadband evolution promulgated by the Third Generation Partnership Project (3GPP). 5G NR may support enhanced mobile broadband (eMBB) access, Internet of Things (IoT) networks or reduced capability (RedCap) device deployments, ultra-reliable low-latency communication (URLLC) applications, and/or massive machine-type communication (mMTC), among other examples.

To support these and other target verticals, a wireless communication system may be designed to implement a modularized functional infrastructure, a disaggregated and service-based network architecture, network function virtualization, network slicing, multi-access edge computing, millimeter wave (mmWave) technologies including massive multiple-input multiple-output (MIMO), beamforming, IoT device or RedCap device connectivity and management, industrial connectivity, licensed and unlicensed spectrum access, sidelink and other device-to-device direct communication (in some aspects, cellular vehicle-to-everything (CV2X) communication), frequency spectrum expansion, overlapping spectrum use, small cell deployments, non-terrestrial network (NTN) deployments, device aggregation, advanced duplex communication (in some aspects, sub-band full-duplex (SBFD)), multiple-subscriber implementations, high-precision positioning, radio frequency (RF) sensing, network energy savings (NES), low-power signaling and radios, and/or artificial intelligence or machine learning (AI/ML), among other examples.

The foregoing and other technological improvements may support use cases, such as wireless fronthauls, wireless midhauls, wireless backhauls, wireless data centers, extended reality (XR) and metaverse applications, meta services for supporting vehicle connectivity, holographic and mixed reality communication, autonomous and collaborative robots, vehicle platooning and cooperative maneuvering, sensing networks, gesture monitoring, human-brain interfacing, digital twin applications, asset management, and universal coverage applications using non-terrestrial and/or aerial platforms, among other examples.

As the demand for connectivity continues to increase, further improvements in NR may be implemented, and other RATs, such as 6G and beyond, may be introduced to enable new applications and facilitate new use cases. The methods, operations, apparatuses, and techniques described herein may enable one or more of the foregoing technologies or new technologies and/or support one or more of the foregoing use cases or new use cases.

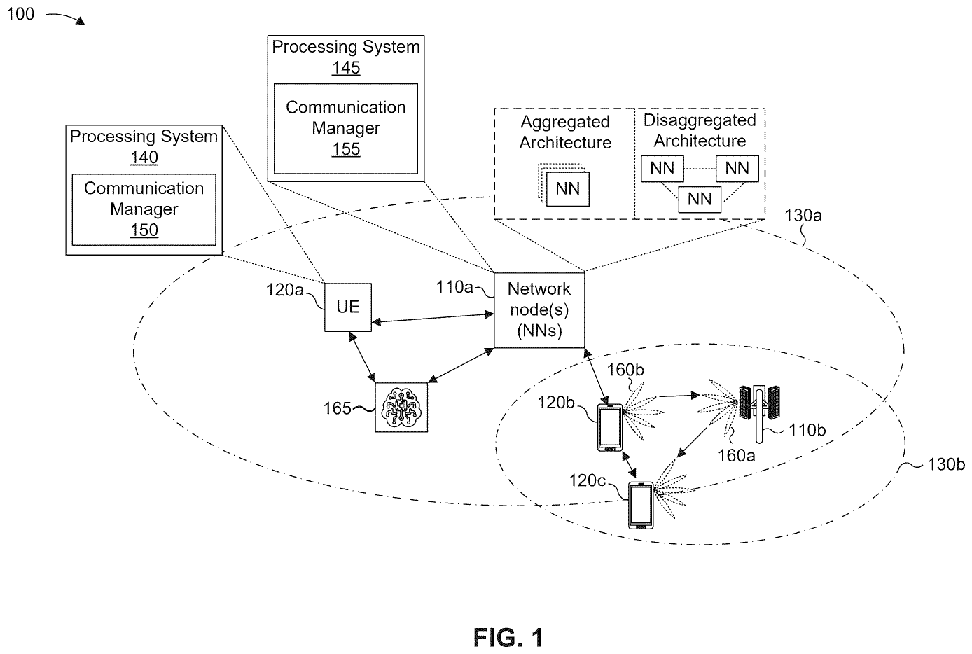

FIG. 1 is a diagram illustrating an example of a wireless communication network 100, in accordance with the present disclosure. The wireless communication network 100 may be or may include elements of a 5G (or NR) network or a 6G network, among other examples. The wireless communication network 100 may include multiple network nodes 110. In some aspects, in FIG. 1, the wireless communication network 100 includes a network node (NN) 110a and a network node 110b. The network nodes 110 may support communications with multiple UEs 120. In some aspects, in FIG. 1, the network nodes 110 support communication with a UE 120a, a UE 120b, and a UE 120c. In some examples, a UE 120 may also communicate with other UEs 120 and a network node 110 may communicate with a core network and with other network nodes 110.

The network nodes 110 and the UEs 120 of the wireless communication network 100 may communicate using the electromagnetic spectrum, which may be subdivided by frequency or wavelength into various classes, bands, carriers, and/or channels. In some aspects, devices of the wireless communication network 100 may communicate using one or more operating bands. In some aspects, multiple wireless communication networks 100 may be deployed in a given geographic area. Each wireless communication network 100 may support a particular RAT (which may also be referred to as an air interface) and may operate on one or more carrier frequencies in one or more frequency bands or ranges. In some examples, when multiple RATs are deployed in a given geographic area, each RAT in the geographic area may operate on different frequencies to avoid interference with other RATs. Additionally or alternatively, in some examples, the wireless communication network 100 may implement dynamic spectrum sharing (DSS), in which multiple RATs are implemented with dynamic bandwidth allocation (in some aspects, based on user demand) in a single frequency band. In some examples, the wireless communication network 100 may support communication over unlicensed spectrum, where access to an unlicensed channel is subject to a channel access mechanism. In some aspects, in a shared or unlicensed frequency band, a transmitting device may perform a channel access procedure, such as a listen-before-talk (LBT) procedure, to contend against other devices for channel access before transmitting on a shared or unlicensed channel.

Various operating bands have been defined as frequency range designations FR1 (410 MHz through 7.125 GHZ), FR2 (24.25 GHz through 52.6 GHZ), FR3 (7.125 GHz through 24.25 GHZ), FR4a or FR4-1 (52.6 GHz through 71 GHZ), FR4 (52.6 GHz through 114.25 GHZ), and FR5 (114.25 GHz through 300 GHz). Although a portion of FR1 is greater than 6 GHZ, FR1 is often referred to (interchangeably) as a “sub-6 GHz” band in some documents and articles. Similarly, FR2 is often referred to (interchangeably) as a “millimeter wave” band in some documents and articles, despite being different than the extremely high frequency (EHF) band (30 GHz through 300 GHz), which is identified by the International Telecommunications Union (ITU) as a “millimeter wave” band. The frequencies between FR1 and FR2 are often referred to as mid-band frequencies, which include FR3. Frequency bands falling within FR3 may inherit FR1 characteristics or FR2 characteristics, and thus may effectively extend features of FR1 or FR2 into the mid-band frequencies. Thus, “sub-6 GHZ,” if used herein, may broadly refer to frequencies that are less than 6 GHZ, that are within FR1, and/or that are included in mid-band frequencies. Similarly, the term “millimeter wave,” if used herein, may broadly refer to mid-band frequencies or to frequencies that are within FR2, FR4, FR4-a or FR4-1, FR5, and/or the EHF band. Higher frequency bands may extend 5G NR operation, 6G operation, and/or other RATs beyond 52.6 GHz.

A network node 110 and/or a UE 120 may include one or more devices, components, or systems that enable communication with other devices, components, or systems of the wireless communication network 100. In some aspects, a UE 120 and a network node 110 may each include one or more chips, system-on-chips (SoCs), chipsets, packages, or devices that individually or collectively constitute or comprise a processing system, such as a processing system 140 of the UE 120 or a processing system 145 of the network node 110. A processing system (in some aspects, the processing system 140 and/or the processing system 145) includes processor (or “processing”) circuitry in the form of one or multiple processors, microprocessors, processing units (such as central processing units (CPUs), graphics processing units (GPUs), neural processing units (NPUs) (also referred to as neural network processors or deep learning processors (DLPs)), and/or digital signal processors (DSPs)), processing blocks, application-specific integrated circuits (ASICs), programmable logic devices (PLDs), or other discrete gate or transistor logic or circuitry (any one or more of which may be generally referred to herein individually as a “processor” or collectively as “the processor” or “the processor circuitry”). Such processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

The processing system 140 and the processing system 145 may each include memory circuitry in the form of one or multiple memory devices, memory blocks, memory elements, or other discrete gate or transistor logic or circuitry, each of which may include or implement tangible storage media such as random-access memory (RAM) or read-only memory (ROM), or combinations thereof (any one or more of which may be generally referred to herein individually as a “memory” or collectively as “the memory” or “the memory circuitry”). One or more of the memories may be coupled (in some aspects, operatively coupled, communicatively coupled, electronically coupled, or electrically coupled) with one or more of the processors and may individually or collectively store processor-executable code or instructions (such as software) that, when executed by one or more of the processors, may configure one or more of the processors to perform various functions or operations described herein. Additionally or alternatively, in some examples, one or more of the processors may be configured to perform various functions or operations described herein without requiring configuration by software. “Software” shall be construed broadly to mean instructions, instruction sets, code, code segments, program code, programs, subprograms, software modules, applications, software applications, software packages, routines, subroutines, objects, executables, threads of execution, procedures, or functions, among other examples, whether referred to as software, firmware, middleware, microcode, hardware description language, or otherwise.

The processing system 140 and the processing system 145 may each include or be coupled with one or more modems (such as a cellular (in some aspects, a 5G or 6G compliant) modem). In some examples, one or more processors of the processing system 140 and/or the processing system 145 include or implement one or more of the modems. The processing system 140 and the processing system 145 may also include or be coupled with multiple radios (collectively “the radio”), multiple RF chains, or multiple transceivers, each of which may in turn be coupled with one or more of multiple antennas. In some examples, one or more processors of the processing system 140 and/or the processing system 145 include or implement one or more of the radios, RF chains, or transceivers. An RF chain may include one or more filters, mixers, oscillators, amplifiers, analog-to-digital converters (ADCs), and/or other devices that convert between an analog signal (such as for transmission or reception via an air interface) and a digital signal (such as for processing by the processing system 140 of the UE 120 or by the processing system 145 of the network node 110).

A network node 110 and a UE 120 may each include one or multiple antennas or antenna arrays. Typical network nodes 110 and UEs 120 may include multiple antennas, which may be organized or structured into one or more antenna panels, one or more antenna groups, one or more sets of antenna elements, or one or more antenna arrays, among other examples. As used herein, the term “antenna” can refer to one or more antennas, one or more antenna panels, one or more antenna groups, one or more sets of antenna elements, or one or more antenna arrays. The term “antenna panel” can refer to a group of antennas (such as antenna elements) arranged in an array or panel, which may facilitate beamforming by manipulating parameters associated with the group of antennas. The term “antenna module” may refer to circuitry including one or more antennas as well as one or more other components (such as filters, amplifiers, or processors) associated with integrating the antenna module into a wireless communication device such as the network node 110 and the UE 120.

A network node 110 may be, may include, or may also be referred to as an NR network node, a 5G network node, a 6G network node, a Node B, a gNB, an access point (AP), a transmission reception point (TRP), a network entity, a network element, a network equipment, and/or another type of device, component, or system included in a radio access network (RAN). In various deployments, a network node 110 may be implemented as a single physical node (in some aspects, a single physical structure) or may be implemented as two or more physical nodes (in some aspects, two or more distinct physical structures). In some aspects, a network node 110 may be a device or system that implements a part of a radio protocol stack, a device or system that implements a full radio protocol stack (such as a full gNB protocol stack), or a collection of devices or systems that collectively implement the full radio protocol stack. In some aspects, and as shown, a network node 110 may be an aggregated network node having an aggregated architecture, meaning that the network node 110 may implement a full radio protocol stack that is physically and logically integrated within a single physical structure in the wireless communication network 100. In some aspects, an aggregated network node 110 may consist of a single standalone base station or a single TRP that operates with a full radio protocol stack to enable or facilitate communication between a UE 120 and a core network of the wireless communication network 100.

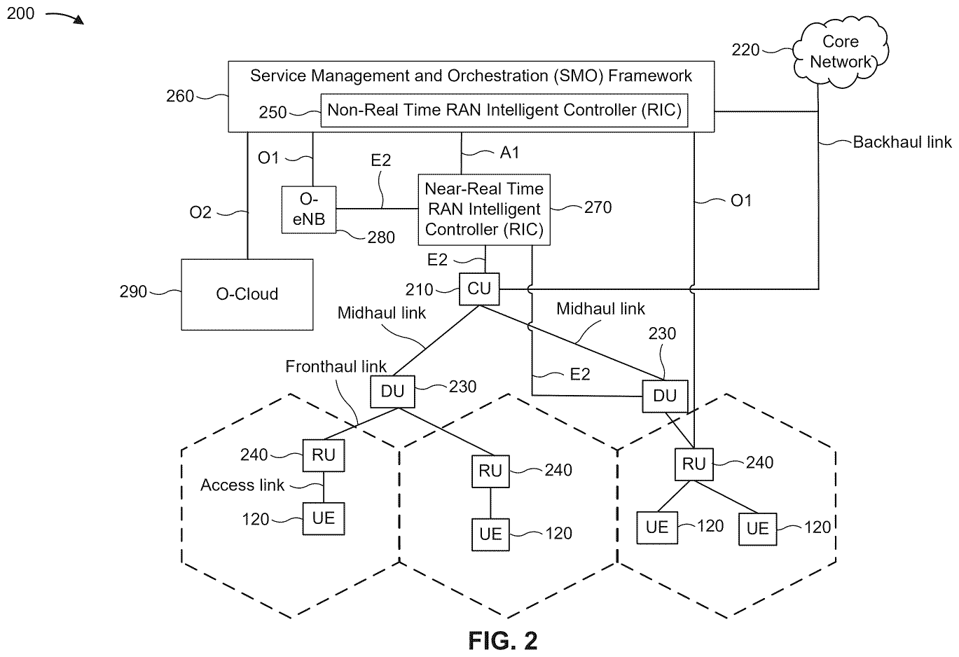

Alternatively, and as also shown, a network node 110 may be a disaggregated network node (sometimes referred to as a disaggregated base station), having a disaggregated architecture, meaning that the network node 110 may operate with a radio protocol stack that is physically distributed and/or logically distributed among two or more nodes in the same geographic location or in different geographic locations. An example disaggregated network node architecture is described in more detail below with reference to FIG. 2. In some deployments, disaggregated network nodes 110 may be used in an integrated access and backhaul (IAB) network, in an open radio access network (O-RAN) (such as a network configuration in compliance with the O-RAN Alliance), or in a virtualized radio access network (vRAN), also known as a cloud radio access network (C-RAN), to facilitate scaling by separating network functionality into multiple units or modules that can be individually deployed.

The network nodes 110 of the wireless communication network 100 may include one or more central units (CUs), one or more distributed units (DUs), and one or more radio units (RUs). A CU may host one or more higher layers, such as a radio resource control (RRC) layer, a packet data convergence protocol (PDCP) layer, and a service data adaptation protocol (SDAP) layer, among other examples. A DU may host one or more of a radio link control (RLC) layer, a medium access control (MAC) layer, and/or one or more higher physical (PHY) layers depending, at least in part, on a functional split, such as a functional split defined by the 3GPP. In some examples, a DU also may host a lower PHY layer that is configured to perform functions, such as a fast Fourier transform (FFT), an inverse FFT (IFFT), beamforming, and/or physical random access channel (PRACH) extraction and filtering, among other examples. An RU may perform RF processing functions or lower PHY layer functions, such as an FFT, an IFFT, beamforming, or PRACH extraction and filtering, among other examples, according to a functional split, such as a lower layer split (LLS). In such an architecture, each RU can be operated to handle over the air (OTA) communication with one or more UEs 120. In some examples, a single network node 110 may include a combination of one or more CUs, one or more DUs, and/or one or more RUs. In some examples, a CU, a DU, and/or an RU may be implemented as a virtual unit, such as a virtual central unit (VCU), a virtual distributed unit (VDU), or a virtual radio unit (VRU), among other examples, which may be implemented as a virtual network function, such as in a cloud deployment.

Some network nodes 110 (in some aspects, a base station, an RU, or a TRP) may provide communication coverage for a particular geographic area. The term “cell” can refer to a coverage area of a network node 110 or to a network node 110 itself, depending on the context in which the term is used. A network node 110 may support one or more cells (in some aspects, each cell may support communication within an angular (in some aspects, 60 degree) range around the network node). In some examples, a network node 110 may provide communication coverage for a macro cell, a pico cell, a femto cell, or another type of cell. A macro cell may cover a relatively large geographic area (in some aspects, several kilometers in radius) and may allow unrestricted access by UEs 120 with associated service subscriptions. A pico cell May cover a relatively small geographic area and may also allow unrestricted access by UEs 120 with associated service subscriptions. A femto cell may cover a relatively small geographic area (in some aspects, a home) and may allow restricted access by UEs 120 having association with the femto cell (in some aspects, UEs 120 in a closed subscriber group (CSG)). In some examples, a cell may not necessarily be stationary. In some aspects, the geographic area of the cell may move according to the location of an associated mobile network node 110 (in some aspects, a train, a satellite, an unmanned aerial vehicle, or an NTN network node).

The wireless communication network 100 may be a heterogeneous network that includes network nodes 110 of different types, such as macro network nodes, pico network nodes, femto network nodes, relay network nodes, aggregated network nodes, and/or disaggregated network nodes, among other examples. Various different types of network nodes 110 may generally transmit at different power levels, serve different coverage areas (in some aspects, a cell 130a and a cell 130b), and/or have different impacts on interference in the wireless communication network 100 than other types of network nodes 110.

The UEs 120 may be physically dispersed throughout the coverage area of the wireless communication network 100, and each UE 120 may be stationary or mobile. A UE 120 may be, may include, or may also be referred to as an access terminal, a mobile station, or a subscriber unit. A UE 120 may be, include, or be coupled with a cellular phone (in some aspects, a smart phone), a personal digital assistant (PDA), a wireless modem, a wireless communication device, a handheld device, a laptop computer, a cordless phone, a wireless local loop (WLL) station, a tablet, a camera, a netbook, a smartbook, an ultrabook, a medical device, a biometric device, a wearable device (in some aspects, a smart watch, smart clothing, smart glasses, a smart wristband, or smart jewelry), a gaming device, an entertainment device (in some aspects, a music device, a video device, or a satellite radio), an XR device, a vehicular component or sensor, a smart meter or sensor, industrial manufacturing equipment, a Global Navigation Satellite System (GNSS) device (such as a Global Positioning System device or another type of positioning device), a UE function of a network node, and/or any other suitable device or function that may communicate via a wireless medium.

Some UEs 120 may be classified according to different categories in association with different complexities and/or different capabilities. UEs 120 in a first category may facilitate massive IoT in the wireless communication network 100, and may offer low complexity and/or cost relative to UEs 120 in a second category. UEs 120 in a second category may include mission-critical IoT devices, legacy UEs, baseline UEs, high-tier UEs, advanced UEs, full-capability UEs, and/or premium UEs that are capable of URLLC, eMBB, and/or precise positioning in the wireless communication network 100, among other examples. A third category of UEs 120 may have mid-tier complexity and/or capability (in some aspects, a capability between that of the UEs 120 of the first category and that of the UEs 120 of the second capability). A UE 120 of the third category may be referred to as a reduced capability UE (“RedCap UE”), a mid-tier UE, an NR-Light UE, and/or an NR-Lite UE, among other examples. RedCap UEs may bridge a gap between the capability and complexity of NB-IoT devices and/or eMTC UEs, and mission-critical IoT devices and/or premium UEs. RedCap UEs may include, in some aspects, wearable devices, IoT devices, industrial sensors, or cameras that are associated with a limited bandwidth, power capacity, and/or transmission range, among other examples. RedCap UEs may support healthcare environments, building automation, electrical distribution, process automation, transport and logistics, or smart city deployments, among other examples.

In some examples, a UE 120 in the third category (a RedCap UE) may support lower latency communication than a UE 120 in the first category (an NB-IoT UE or an eMTC UE), and a UE 120 in the second category (a mission-critical IoT UE or a premium UE) may support lower latency communication than the UE 120 in the third category. Additionally or alternatively, in some examples, a UE 120 in the third category (a RedCap UE) may support higher wireless communication throughput than a UE 120 in the first category (an NB-IoT UE or an eMTC UE), and a UE 120 in the second category (a mission-critical IoT UE or a premium UE) may support higher wireless communication throughput than the UE 120 in the third category. Additionally or alternatively, in some examples, a UE 120 in the first category (an NB-IoT UE or an eMTC UE) may support longer battery life than a UE 120 in the third category (a RedCap UE), and the UE 120 in the third category may support longer battery life than a UE 120 in the second category (a mission-critical IoT UE or a premium UE).

In some examples, a UE 120 of the third category (a RedCap UE) may have capabilities that satisfy first device or performance requirements but not second device or performance requirements (such as parameters specified for NR UEs 120 other than UEs 120 of the third category), while a UE 120 of the second category (a mission-critical IoT UE or a premium UE) may have capabilities that satisfy the second device or performance requirements (and also the first device or performance requirements, in some examples). In some aspects, a UE 120 of the third category may support a lower maximum MCS (in some aspects, a modulation scheme such as quadrature phase shift keying (QPSK)) than an MCS supported by a UE 120 of the second category (in some aspects, a modulation scheme such as 256-quadrature amplitude modulation (QAM)).

As another example, a UE 120 of the third category may support a lower maximum transmit power than a maximum transmit power of a UE 120 of the second category. As another example, a UE 120 of the third category may have a less advanced beamforming capability than a beamforming capability of a UE 120 of the second category (in some aspects, a RedCap UE may not be capable of forming as many beams as a premium UE). As another example, a UE 120 of the third category may require a longer processing time than a processing time of a UE 120 of the second category. As another example, a UE 120 of the third category may include less hardware or less complex hardware (such as fewer antennas, fewer transmit antennas, and/or fewer receive antennas) than a UE 120 of the second category. As another example, a UE 120 of the third category may not be capable of communicating on as wide of a maximum bandwidth part (BWP) (e.g., further described below) as a UE 120 of the second category.

In some examples, a network node 110 may be, may include, or may operate as an RU, a TRP, or a base station that communicates with one or more UEs 120 via a radio access link (which may be referred to as a “Uu” link). The radio access link may include a downlink and an uplink. “Downlink” (or “DL”) refers to a communication direction from a network node 110 to a UE 120, and “uplink” (or “UL”) refers to a communication direction from a UE 120 to a network node 110. Downlink and uplink resources may include time domain resources (in some aspects, frames, subframes, slots, and symbols), frequency domain resources (in some aspects, frequency bands, component carriers (CCs), subcarriers, resource blocks, and resource elements), and spatial domain resources (in some aspects, particular transmit directions or beams).

Frequency domain resources may be subdivided into BWPs. A BWP may be a block of frequency domain resources (in some aspects, a continuous set of resource blocks (RBs) within a full component carrier bandwidth) that may be configured at a UE-specific level. A UE 120 may be configured with both an uplink BWP and a downlink BWP (which may be the same or different). Each BWP may be associated with its own numerology (indicating a sub-carrier spacing (SCS) and cyclic prefix (CP)). A BWP may be dynamically configured or activated (in some aspects, by a network node 110 transmitting a downlink control information (DCI) configuration to the one or more UEs 120) and/or reconfigured (in some aspects, in real-time or near-real-time) according to changing network conditions in the wireless communication network 100 and/or specific requirements of one or more UEs 120. An active BWP defines the operating bandwidth of the UE 120 within the operating bandwidth of the serving cell. The use of BWPs enables more efficient use of the available frequency domain resources in the wireless communication network 100 because fewer frequency domain resources may be allocated to a BWP for a UE 120 (which may reduce the quantity of frequency domain resources that a UE 120 is required to monitor and reduce UE power consumption by enabling the UE to monitor fewer frequency domain resources), leaving more frequency domain resources to be spread across multiple UEs 120. Thus, BWPs may also assist in the implementation of lower-capability (in some aspects, RedCap) UEs 120 by facilitating the configuration of smaller bandwidths for communication by such UEs 120 and/or by facilitating reduced UE power consumption.

As used herein, a downlink signal may be or include a reference signal, control information, or data. In some aspects, downlink reference signals include a primary synchronization signal (PSS), a secondary SS (SSS), an SS block (SSB) (in some aspects, that includes a PSS, an SSS, and a physical broadcast channel (PBCH)), a demodulation reference signal (DMRS), a phase tracking reference signal (PTRS), a tracking reference signal (TRS), and a channel state information (CSI) reference signal (CSI-RS), among other examples. A downlink signal carrying control information or data may be transmitted via a downlink channel. Downlink channels may include one or more control channels for transmitting control information and one or more data channels for transmitting data. Downlink reference signals may be transmitted in addition to, or multiplexed with, downlink control channel communications and/or downlink data channel communications. A downlink control channel may be specifically used to transmit DCI from a network node 110 to a UE 120. DCI generally contains the information the UE 120 needs to identify RBs in a subsequent subframe and how to decode them, including a modulation and coding scheme (MCS) or redundancy version parameters. Different DCI formats carry different information, such as scheduling information in the form of downlink or uplink grants, slot format indicators (SFIs), preemption indicators (PIS), transmit power control (TPC) commands, hybrid automatic repeat request (HARQ) information, new data indicators (NDIs), among other examples. A downlink data channel may be used to transmit downlink data (in some aspects, user data associated with a UE 120) from a network node 110 to a UE 120. Downlink control channels may include physical downlink control channels (PDCCHs), and downlink data channels may include physical downlink shared channels (PDSCHs). Control information or data communications may be transmitted on a PDCCH and PDSCH, respectively. In some aspects, a PDCCH can carry DCI, while a PDSCH can carry a MAC control element (MAC-CE), an RRC message, or user data, among other examples. Each PDSCH may carry one or more transport blocks (TBs) of data.

As used herein, an uplink signal may include a reference signal, control information, or data. In some aspects, uplink reference signals include a sounding reference signal (SRS), a PTRS, and a DMRS, among other examples. An uplink signal carrying control information or data may be transmitted via an uplink channel. An uplink channel may include one or more control channels for transmitting control information and one or more data channels for transmitting data. Uplink reference signals may be transmitted in addition to, or multiplexed with, uplink control channel communications and/or uplink data channel communications. An uplink control channel may be specifically used to transmit uplink control information (UCI) from a UE 120 to a network node 110. An uplink data channel may be used to transmit uplink data (in some aspects, user data associated with a UE 120) from a UE 120 to a network node 110. Uplink control channels may include physical uplink control channels (PUCCHs), and uplink data channels may include physical uplink shared channels (PUSCHs). Control information or data communications may be transmitted on a PUCCH and PUSCH, respectively. In some aspects, a PUCCH can carry UCI, while a PUSCH can carry a MAC-CE, an RRC message, or user data, among other examples. UCI can include a scheduling request (SR), HARQ feedback information (in some aspects, a HARQ acknowledgement (ACK) indication or a HARQ negative acknowledgement (NACK) indication), uplink power control information (in some aspects, an uplink TPC parameter), and/or CSI, among other examples. CSI can include a channel quality indicator (CQI) (indicative of downlink channel conditions to facilitate selection of transmission parameters, such as an MCS, by a network node 110), a precoding matrix indicator (PMI), a CSI-RS resource indicator (CRI) (in some aspects, indicative of a beam used to transmit a CSI-RS), an SS/PBCH resource block indicator (SSBRI) (in some aspects, indicative of a beam used to transmit an SSB), a layer indicator (LI), a rank indicator (RI), and/or measurement information (in some aspects, a layer 1 (L1)-reference signal received power (RSRP) parameter, a received signal strength indicator (RSSI) parameter, a reference signal received quality (RSRQ) parameter, among other examples) which can be used for beam management, among other examples. Each PUSCH may carry one or more TBs of data.

The information (in some aspects, data, control information, or reference signal information) transmitted by a network node 110 to a UE 120, or vice versa, may be represented as a sequence of binary bits that are mapped (in some aspects, modulated) to an analog signal waveform (in some aspects, a discrete Fourier transform (DFT)-spread-orthogonal frequency division multiplexing (OFDM) (DFT-s-OFDM) waveform or a CP-OFDM waveform) that is transmitted by the network node 110 or UE 120 over a wireless communication channel. In some examples, the network node 110 or the UE 120 (in some aspects, using the processing system 145 or the processing system 140, respectively) may select an MCS (in some aspects, an order of quadrature amplitude modulation (QAM), such as 64-QAM, 128-QAM, or 256-QAM, among other examples) for a downlink signal or an uplink signal. In some aspects, the network node 110 may select an MCS for a downlink signal in accordance with UCI received from the UE 120. The network node 110 may transmit, to the UE 120, an indication of the selected MCS for the downlink signal, such as via DCI that schedules the downlink signal. As another example, the network node 110 may transmit, and the UE 120 may receive, an indication of an MCS to be applied for the one or more uplink signals, such as via DCI scheduling transmission of the one or more uplink signals.

The network node 110 or the UE 120 (such as by using the processing system 145 or the processing system 140, respectively, and/or one or more coupled modems) may perform signal processing on the information (such as filtering, amplification, modulation, digital-to-analog conversion, an IFFT operation, multiplexing, interleaving, mapping, and/or encoding, among other examples) to generate a processed signal in accordance with the selected MCS. In some examples, the network node 110 or the UE 120 (in some aspects, using the processing system 145 or the processing system 140, respectively, and/or one or more coupled encoders or modems) may perform a channel coding operation or a forward error correction (FEC) operation to control errors in transmitted information. In some aspects, the network node 110 or the UE 120 may perform an encoding operation to generate encoded information (such as by selectively introducing redundancy into the information, typically using an error correction code (ECC), such as a polar code or a low-density parity-check (LDPC) code). The network node 110 or the UE 120 (in some aspects, using the processing system 145 and/or one or more modems) may further perform spatial processing (in some aspects, precoding) on the encoded information to generate one or more processed or precoded signals for downlink or uplink transmission, respectively. In some examples, the network node 110 or the UE 120 may perform codebook-based precoding or non-codebook-based precoding. Codebook-based precoding may involve selecting a precoder (in some aspects, a precoding matrix) using a codebook. In some aspects, the network node 110 may provide precoding information indicating which precoder, defined by the codebook, is to be used by the UE 120. Non-codebook-based precoding may involve selecting or deriving a precoder based on, or otherwise associated with, one or more downlink or uplink signal measurements. The network node 110 or the UE 120 may transmit the processed downlink or uplink signals, respectively, via one or more antennas.

The network node 110 or the UE 120 may receive uplink signals or downlink signals, respectively, via one or more antennas. The network node 110 or the UE 120 (in some aspects, using the processing system 145 or the processing system 140, respectively, and/or one or more coupled modems) may perform signal processing (in some aspects, in accordance with the MCS) on the received uplink or downlink signals, respectively (such as filtering, amplification, demodulation, analog-to-digital conversion, an FFT operation, demultiplexing, deinterleaving, de-mapping, equalization, interference cancellation, and/or decoding, among other examples), to map the received signal(s) to a sequence of binary bits (in some aspects, received information) that estimates the information transmitted by the network node 110 or the UE 120 via the downlink or uplink signals. The network node 110 or the UE 120 (in some aspects, using the processing system 145 or the processing system 140, respectively, and/or a coupled decoder or one or more modems) may decode the received information (such as by using an ECC, a decoding operation, and/or an FEC operation) to detect errors and/or correct bit errors in the received information to generate decoded information. The decoded information may estimate the information transmitted via the downlink or uplink signals.

In some examples, a UE 120 and a network node 110 may perform MIMO communication. “MIMO” generally refers to transmitting or receiving multiple signals (such as multiple layers or multiple data streams) simultaneously over the same time and frequency resources. MIMO techniques generally exploit multipath propagation. A network node 110 and/or UE 120 may communicate using massive MIMO, multi-user MIMO, or single-user MIMO, which may involve rapid switching between beams or cells. In some aspects, the amplitudes and/or phases of signals transmitted via antenna elements and/or sub-elements may be modulated and shifted relative to each other (such as by manipulating a phase shift, a phase offset, and/or an amplitude) to generate one or more beams, which is referred to as beamforming. In some aspects, the network node 110b may generate one or more beams 160a, and the UE 120b may generate one or more beams 160b. The term “beam” may refer to a directional transmission of a wireless signal toward a receiving device or otherwise in a desired direction, a directional reception of a wireless signal from a transmitting device or otherwise in a desired direction, a direction associated with a directional transmission or directional reception, a set of directional resources associated with a signal transmission or signal reception (in some aspects, an angle of arrival, a horizontal direction, and/or a vertical direction), a set of parameters that indicate one or more aspects of a directional signal, a direction associated with the signal, and/or a set of directional resources associated with the signal, among other examples.

MIMO may be implemented using various spatial processing or spatial multiplexing operations. In some examples, MIMO may include a massive MIMO technique which may be associated with an increased (in some aspects, “massive”) quantity of antennas at the network node 110 and/or at the UE 120, such as in a network implementing mmWave technology. Massive MIMO may improve communication reliability by enabling a network node 110 and/or a UE 120 to communicate the same data across different propagation (or spatial) paths. In some examples, MIMO may support simultaneous transmission to multiple receivers, referred to as multi-user MIMO (MU-MIMO). Some RATs may employ MIMO techniques, such as multi-TRP (mTRP) operation (including redundant transmission or reception on multiple TRPs), reciprocity in the time domain or the frequency domain, single-frequency-network (SFN) transmission, or non-coherent joint transmission (NC-JT).

To support MIMO techniques, the network node 110 and the UE 120 may perform one or more beam management operations, such as an initial beam acquisition operation, one or more beam refinement operations, and/or a beam recovery operation. In some aspects, an initial beam acquisition operation may involve the network node 110 transmitting signals (in some aspects, SSBs, CSI-RSs, or other signals) via respective beams (in some aspects, of the beams 160a of the network node 110) and the UE 120 receiving and measuring the signal(s) via respective beams of multiple beams (in some aspects, from the beams 160b of the UE 120) to identify a best beam (or beam pair) for communication between the UE 120 and the network node 110. In some aspects, the UE 120 may transmit an indication (in some aspects, in a message associated with a random access channel (RACH) operation) of a (best) identified beam of the network node 110 (in some aspects, by indicating an SSBRI or other identifier associated with the beam). A beam refinement operation may involve a first device (in some aspects, the UE 120 or the network node 110) transmitting signal(s) via a subset of beams (in some aspects, identified based on, or otherwise associated with, measurements reported as part of one or more other beam management operations). A second device (in some aspects, the network node 110 or the UE 120) may receive the signal(s) via a single beam (in some aspects, to identify the best beam for communication from the subset of beams). The beam(s) may be identified via one or more spatial parameters, such as a transmission configuration indicator (TCI) state and/or a quasi co-location (QCL) parameter, among other examples. The network node 110 and the UE 120 may increase reliability and/or achieve efficiencies in throughput, signal strength, and/or other signal properties for massive MIMO operations by performing the beam management operations.

Some aspects and techniques as described herein may be implemented, at least in part, using an artificial intelligence (AI) program (in some aspects, referred to herein as an “AI/ML model”), such as a program that includes a machine learning (ML) model and/or an artificial neural network (ANN) model. The AI/ML model may be deployed at one or more devices 165 (in some aspects, one or more network nodes 110, one or more UEs 120, and/or one or more servers, and/or one or more components of a cloud computing network, among other examples). In some aspects, in an deployment where AI/ML functionality is performed independently at a device 165, sometimes referred to as “overlay AI/ML”, the AI/ML model (or an instance or portion of the AI/ML model) may be deployed at a UE 120 (in some aspects, at the processing system 140), a network node 110 (in some aspects, at the processing system 145), one or more servers, and/or one or more components of a cloud computing network, among other examples. Additionally or alternatively, in a deployment where AI/ML functionality is coordinated between different devices 165, sometimes referred to as “coordinated AI/ML”, or performed at all device and network layers, sometimes referred to as “native AI/ML”, the AI/ML model (or an instance of the AI/ML model) may be deployed at multiple devices 165 (in some aspects, a first portion of the AI/ML model may be deployed at a UE 120 and a second portion of the AI/ML model may be deployed at a network node 110). In other examples of coordinated AI/ML and/or native AI/ML, a first AI/ML model may be deployed at a UE 120 and a second AI/ML model may be deployed at a network node 110. The AI/ML model(s) may be configured to enhance various aspects of the wireless communication network 100 (in some aspects, to increase privacy, reliability, and/or efficient use of network bandwidth, and/or to reduce latency, among other examples). In some aspects, the AI/ML model(s) may be trained to identify patterns or relationships in data corresponding to the wireless communication network 100, a device, and/or an air interface, among other examples. The AI/ML model(s) may support operational decisions relating to one or more aspects associated with wireless communications devices, networks, or services.

Accordingly, in some examples, the AI/ML model(s) may enable AI-as-a-Service (in some aspects, an end-to-end AI/ML service via a user plane) for use cases such as a self-organizing network (SON), minimization of drive test (MDT), quality of experience (QoE), positioning, sensing, predictive mobility, and/or traffic prediction, among other examples. In some examples, AI-as-a-Service use cases may include measurement collection reporting by a UE 120, device selection criteria (in some aspects, according to a geographical area where measurements are to be collected and/or UE capabilities to be used to collected measurements), and/or reporting configurations (in some aspects, reporting parameters such as location, time, and/or sensor information, among other examples). Additionally or alternatively, the AI/ML model(s) may enable AI/ML procedures (in some aspects, RAN-triggered service establishment, configuration, inferencing using UE-side and/or network-side models, performance monitoring and/or management, and/or capability signaling, among other examples). Additionally or alternatively, the AI/ML model(s) may enable RAN-based AI/ML services via one or more application program interfaces (APIs) and/or management interfaces for use cases such as beam management, radio resource monitoring (RRM) relaxation, mobility prediction, load prediction, network energy savings, and/or coverage and capacity improvements, among other examples).

In some aspects, the UE 120 may include a communication manager 150. As described in more detail elsewhere herein, the communication manager 150 may receive, from the network node 110 via a first random access message as part of a random access procedure, an uplink resource grant associated with a first set of capabilities, wherein the UE 120 is associated with a second set of capabilities; and may transmit, via a modified uplink resource grant, a second random access message in accordance with identifying that the uplink resource grant is incompatible with the second set of capabilities. Additionally, or alternatively, the communication manager 150 may perform one or more other operations described herein.

In some aspects, the network node 110 may include a communication manager 155. As described in more detail elsewhere herein, the communication manager 155 may transmit, to the UE via a first random access message as part of a random access procedure, an uplink resource grant associated with a first set of UE capabilities, wherein the UE 120 is associated with a second set of UE capabilities; and receive, via a modified uplink resource grant in accordance with the UE 120 being associated with the second set of UE capabilities, a second random access message. Additionally, or alternatively, the communication manager 155 may perform one or more other operations described herein.

FIG. 2 is a diagram illustrating an example disaggregated network node architecture 200, in accordance with the present disclosure. One or more components of the example disaggregated network node architecture 200 may be, may include, or may be included in one or more network nodes (such one or more network nodes 110). The disaggregated network node architecture 200 may include a CU 210 that can communicate directly with a core network 220 via a backhaul link, or that can communicate indirectly with the core network 220 via one or more disaggregated control units, such as a non-real-time (Non-RT) RAN intelligent controller (RIC) 250 associated with a Service Management and Orchestration (SMO) Framework 260 and/or a near-real-time (Near-RT) RIC 270 (in some aspects, via an E2 link). The CU 210 may communicate with one or more DUs 230 via respective midhaul links, such as via F1 interfaces. Each of the DUs 230 may communicate with one or more RUs 240 via respective fronthaul links. Each of the RUs 240 may communicate with one or more UEs 120 via respective RF access links. In some deployments, a UE 120 may be simultaneously served by multiple RUs 240.

Each of the components of the disaggregated network node architecture 200, including the CUs 210, the DUs 230, the RUs 240, the Near-RT RICs 270, the Non-RT RICs 250, and the SMO Framework 260, may include one or more interfaces or may be coupled with one or more interfaces for receiving or transmitting signals, such as data or information, via a wired or wireless transmission medium.

In some aspects, the CU 210 may be logically split into one or more CU user plane (CU-UP) units and one or more CU control plane (CU-CP) units. A CU-UP unit may communicate bidirectionally with a CU-CP unit via an interface, such as the E1 interface when implemented in an O-RAN configuration. The CU 210 may be deployed to communicate with one or more DUs 230, as necessary, for network control and signaling. Each DU 230 may correspond to a logical unit that includes one or more base station functions to control the operation of one or more RUs 240. In some aspects, a DU 230 may host various layers, such as an RLC layer, a MAC layer, or one or more PHY layers, such as one or more high PHY layers or one or more low PHY layers. Each layer (which also may be referred to as a module) may be implemented with an interface for communicating signals with other layers (and modules) hosted by the DU 230, or for communicating signals with the control functions hosted by the CU 210. Each RU 240 may implement lower layer functionality. In some aspects, real-time and non-real-time aspects of control and user plane communication with the RU(s) 240 may be controlled by the corresponding DU 230.

The SMO Framework 260 may support RAN deployment and provisioning of non-virtualized and virtualized network elements. For non-virtualized network elements, the SMO Framework 260 may support the deployment of dedicated physical resources for RAN coverage requirements, which may be managed via an operations and maintenance interface, such as an O1 interface. For virtualized network elements, the SMO Framework 260 may interact with a cloud computing platform (such as an open cloud (O-Cloud) platform 290) to perform network element life cycle management (such as to instantiate virtualized network elements) via a cloud computing platform interface, such as an O2 interface. A virtualized network element may include, but is not limited to, a CU 210, a DU 230, an RU 240, a non-RT RIC 250, and/or a Near-RT RIC 270. In some aspects, the SMO Framework 260 may communicate with a hardware aspect of a 4G RAN, a 5G NR RAN, and/or a 6G RAN, such as an open eNB (O-eNB) 280, via an O1 interface. Additionally or alternatively, the SMO Framework 260 may communicate directly with each of one or more RUs 240 via a respective O1 interface. In some deployments, this configuration can enable each DU 230 and the CU 210 to be implemented in a cloud-based RAN architecture, such as a vRAN architecture.

The Non-RT RIC 250 may include or may implement a logical function that enables non-real-time control and optimization of RAN elements and resources, AI/ML workflows including model training and updates, and/or policy-based guidance of applications and/or features in the Near-RT RIC 270. The Non-RT RIC 250 may be coupled to or may communicate with (such as via an A1 interface) the Near-RT RIC 270. The Near-RT RIC 270 may include or may implement a logical function that enables near-real-time control and optimization of RAN elements and resources via data collection and actions via an interface (such as via an E2 interface) connecting one or more CUs 210, one or more DUs 230, and/or an O-eNB 280 with the Near-RT RIC 270.

In some aspects, to generate AI/ML models to be deployed in the Near-RT RIC 270, the Non-RT RIC 250 may receive parameters or external enrichment information from external servers. Such information may be utilized by the Near-RT RIC 270 and may be received at the SMO Framework 260 or the Non-RT RIC 250 from non-network data sources or from network functions. In some examples, the Non-RT RIC 250 or the Near-RT RIC 270 may tune RAN behavior or performance. In some aspects, the Non-RT RIC 250 may monitor long-term trends and patterns for performance and may employ AI/ML models to perform corrective actions via the SMO Framework 260 (such as reconfiguration via an O1 interface) or via creation of RAN management policies (such as A1 interface policies).

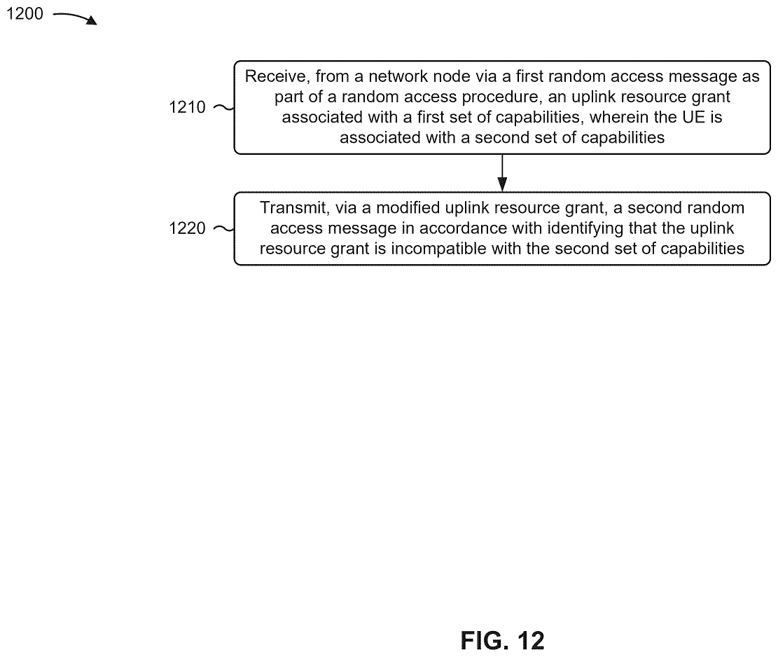

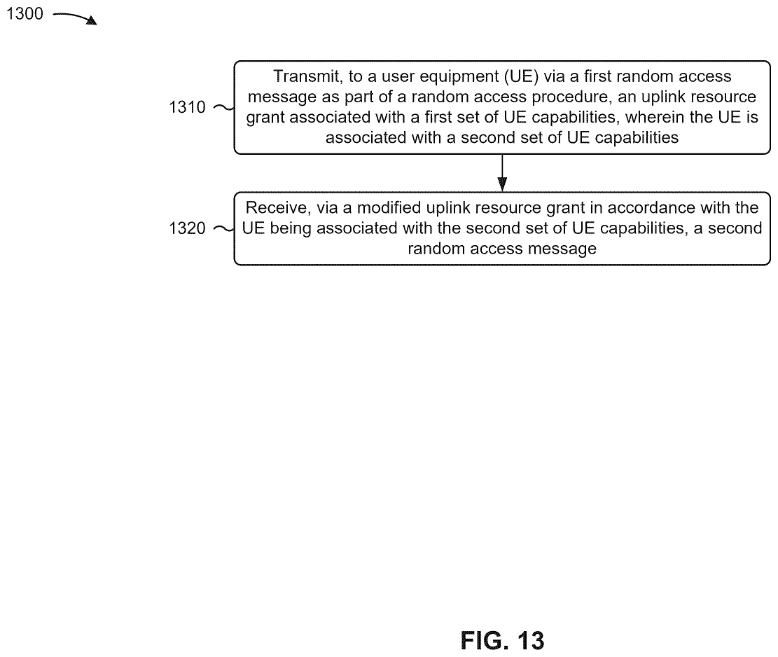

The network node 110, the processing system 145 of the network node 110, the UE 120, the processing system 140 of the UE 120, the CU 210, the DU 230, the RU 240, or any other component(s) of FIG. 1 and/or FIG. 2 may implement one or more techniques or perform one or more operations associated with random access message based indication of UE capabilities, as described in more detail elsewhere herein. In some aspects, the processing system 145 of the network node 110, the processing system 140 of the UE 120, the CU 210, the DU 230, or the RU 240 may perform or direct operations of, in some aspects, process 1200 of FIG. 12, process 1300 of FIG. 13, or other processes as described herein (alone or in conjunction with one or more other processors). Memory of the network node 110 may store data and program code (or instructions) for the network node 110, the CU 210, the DU 230, or the RU 240. In some examples, the memory of the network node 110 may store data relating to a UE 120, such as RRC state information or a UE context. Memory of a UE 120 may store data and program code (or instructions) for the UE 120, such as context information. In some examples, the memory of the UE 120 or the memory of the network node 110 may include a non-transitory computer-readable medium storing a set of instructions for wireless communication. In some aspects, the set of instructions, when executed by one or more processors (in some aspects, of the processing system 145 or the processing system 140) of the network node 110, the UE 120, the CU 210, the DU 230, or the RU 240, may cause the one or more processors to perform process 1200 of FIG. 12, process 1300 of FIG. 13, or other processes as described herein. In some examples, executing instructions may include running the instructions, converting the instructions, compiling the instructions, and/or interpreting the instructions, among other examples.

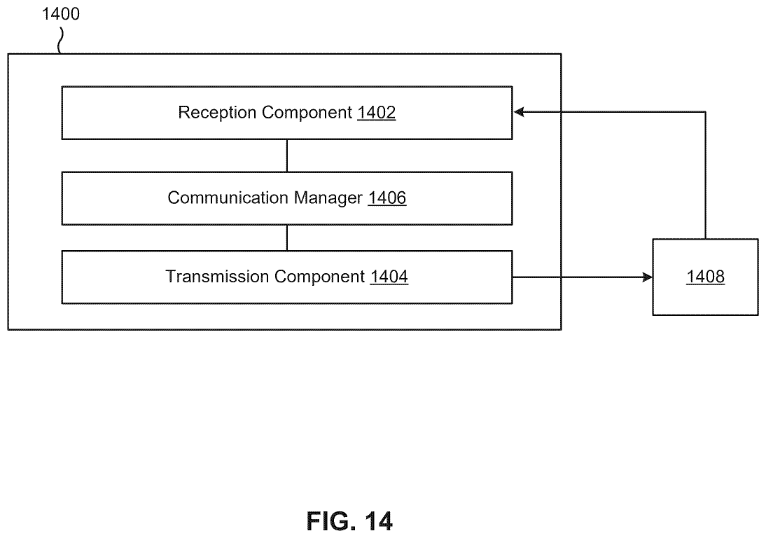

In some aspects, the UE 120 includes means for receiving, from the network node 110 via a first random access message as part of a random access procedure, an uplink resource grant associated with a first set of capabilities, wherein the UE 120 is associated with a second set of capabilities; and/or means for transmitting, via a modified uplink resource grant, a second random access message in accordance with identifying that the uplink resource grant is incompatible with the second set of capabilities. The means for the UE 120 to perform operations described herein may include, in some aspects, one or more of communication manager 150, processing system 140, a radio, one or more RF chains, one or more transceivers, one or more antennas, one or more modems, a reception component (in some aspects, reception component 1402 depicted and described in connection with FIG. 14), and/or a transmission component (in some aspects, transmission component 1404 depicted and described in connection with FIG. 14), among other examples.

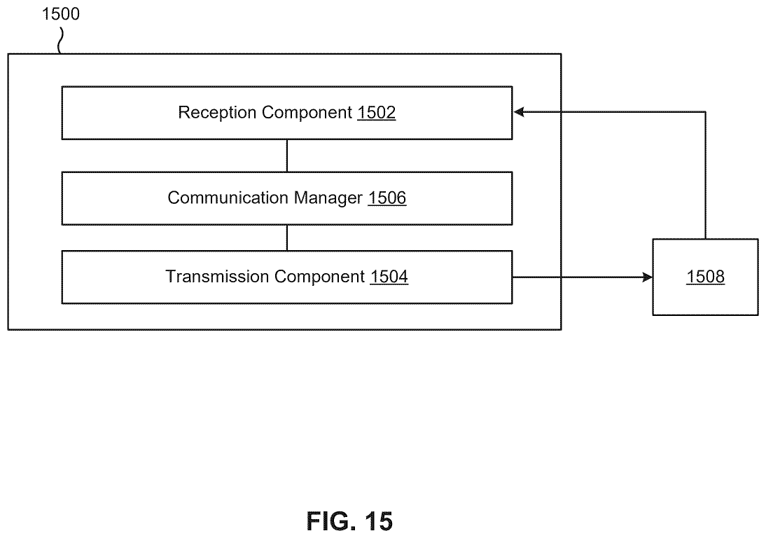

In some aspects, the network node 110 includes means for transmitting, to the UE 120 via a first random access message as part of a random access procedure, an uplink resource grant associated with a first set of UE capabilities, wherein the UE 120 is associated with a second set of UE capabilities; and/or means for receiving, via a modified uplink resource grant in accordance with the UE 120 being associated with the second set of UE capabilities, a second random access message. The means for the network node 110 to perform operations described herein may include, in some aspects, one or more of communication manager 155, processing system 145, a radio, one or more RF chains, one or more transceivers, one or more antennas, one or more modems, a reception component (in some aspects, reception component 1502 depicted and described in connection with FIG. 15), and/or a transmission component (in some aspects, transmission component 1504 depicted and described in connection with FIG. 15), among other examples.

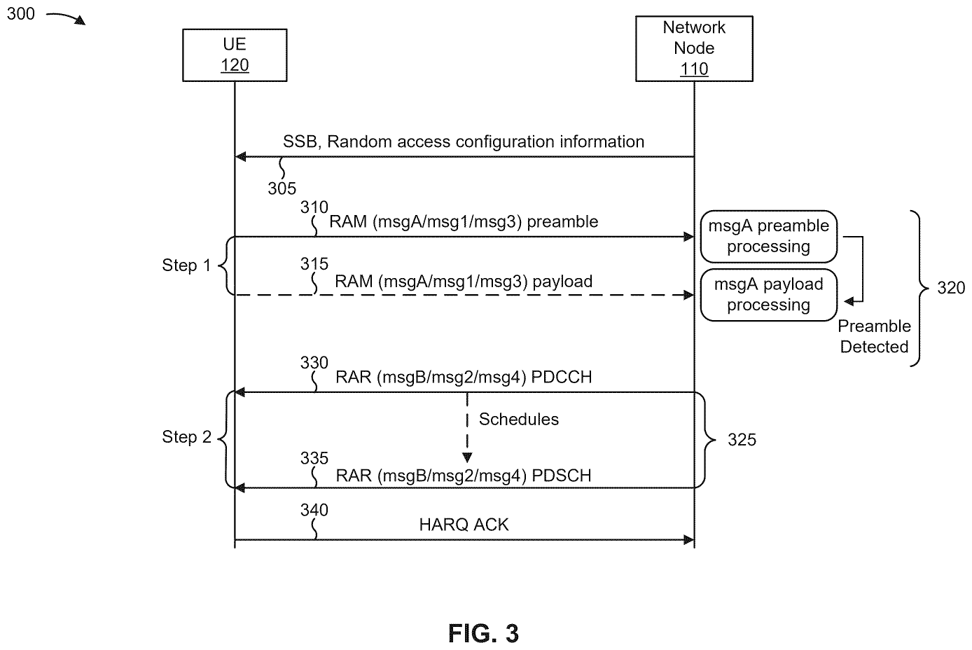

FIG. 3 is a diagram illustrating an example 300 including aspects of a two-step random access procedure and a four-step random access procedure that supports random access message based indication of UE capabilities, in accordance with the present disclosure. As shown in FIG. 3, a network node 110 and a UE 120 may communicate with one another to perform the two-step random access procedure and/or the four-step random access procedure.

As shown by reference number 305, the network node 110 may transmit, and the UE 120 may receive, one or more SSBs and/or random access configuration information. In some aspects, the random access configuration information may be transmitted in and/or indicated by system information (e.g., in one or more SIBs) and/or an SSB, such as for contention-based random access. Additionally, or alternatively, the random access configuration information may be transmitted in an RRC message and/or a PDCCH order message that triggers a RACH procedure, such as for contention-free random access. The random access configuration information may include one or more parameters to be used in the two-step random access procedure and/or the four-step random access procedure, such as one or more parameters for transmitting a random access message (RAM) and/or receiving an RAR to the RAM.

As shown by reference number 310, in the example of a two-step random access procedure, the UE 120 may transmit, and the network node 110 may receive, a RAM preamble. As shown by reference number 315, in the example of a two-step random access procedure, the UE 120 may transmit, and the network node 110 may receive, a RAM payload. As shown, the UE 120 may transmit the RAM preamble and the RAM payload to the network node 110 as part of an initial (or first) step of the two-step random access procedure. In some aspects, the RAM may be referred to as message A, msgA, a first message, or an initial message in a two-step random access procedure. Furthermore, in some aspects, the RAM preamble may be referred to as a message A preamble, a msgA preamble, a preamble, or a PRACH preamble, and the RAM payload may be referred to as a message A payload, a msgA payload, or a payload. In some aspects, the RAM may include some or all of the contents of message 1 (msg1) and message 3 (msg3) of a four-step random access procedure, which is described in more detail below. In some aspects, the RAM preamble may include some or all contents of message 1 (e.g., a PRACH preamble), and the RAM payload may include some or all contents of message 3 (e.g., a UE identifier, UCI, and/or a PUSCH) transmission.

As shown by reference number 310 and/or reference number 315, in the example of a four-step random access procedure, the UE 120 may transmit a RAM, which may include a preamble (sometimes referred to as a random access preamble, a PRACH preamble, or a RAM preamble). The message that includes the preamble may be referred to as a message 1, msg1, MSG1, a first message, or an initial message in a four-step random access procedure. The random access message may include a random access preamble identifier.

As shown by reference number 310 and/or reference number 315, in the example of a four-step random access procedure, the UE 120 may transmit an RRC connection request message. The RRC connection request message may be referred to as message 3, msg3, MSG3, or a third message of a four-step random access procedure. In some aspects, the RRC connection request may include a UE identifier, UCI, and/or a PUSCH communication (e.g., an RRC connection request).

As shown by reference number 320, in the example of a two-step random access procedure, the network node 110 may receive the RAM preamble transmitted by the UE 120. If the network node 110 successfully receives and decodes the RAM preamble, the network node 110 may then receive and decode the RAM payload.

As shown by reference number 325, in the example of a two-step random access procedure, the network node 110 may transmit an RAR (sometimes referred to as an RAR message). As shown, the network node 110 may transmit the RAR message as part of a second step of the two-step random access procedure. In some aspects, the RAR message may be referred to as message B, msgB, or a second message in a two-step random access procedure. The RAR message may include some or all of the contents of message 2 (msg2) and message 4 (msg4) of the four-step random access procedure. In some aspects, the RAR message may include the detected PRACH preamble identifier, the detected UE identifier, a timing advance value, and/or contention resolution information.

As shown by reference number 330, in the example of a two-step random access procedure, as part of the second step of the two-step random access procedure, the network node 110 may transmit a PDCCH communication for the RAR. The PDCCH communication may schedule a PDSCH communication that includes the RAR. In some aspects, the PDCCH communication may indicate a resource allocation (e.g., in DCI) for the PDSCH communication.

As shown by reference number 330 and/or reference number 335, in the example of a four-step random access procedure, the network node 110 may transmit an RAR as a reply to the preamble. The message that includes the RAR may be referred to as message 2, msg2, MSG2, or a second message in a four-step random access procedure. In some aspects, the RAR may indicate the detected random access preamble identifier (e.g., received from the UE 120 in msg1). Additionally, or alternatively, the RAR may indicate a resource allocation to be used by the UE 120 to transmit message 3 (msg3).

In some aspects, as part of the second step of the four-step random access procedure, the network node 110 may transmit a PDCCH communication for the RAR. The PDCCH communication may schedule a PDSCH communication that includes the RAR. In some aspects, the PDCCH communication may indicate a resource allocation for the PDSCH communication. Also as part of the second step of the four-step random access procedure, the network node 110 may transmit the PDSCH communication for the RAR, as scheduled by the PDCCH communication. The RAR may be included in a MAC protocol data unit (PDU) of the PDSCH communication.

As shown by reference number 335, in the example of a two-step random access procedure, as part of the second step of the two-step random access procedure, the network node 110 may transmit the PDSCH communication for the RAR, as scheduled by the PDCCH communication. The RAR may be included in a MAC PDU of the PDSCH communication. As shown by reference number 340, if the UE 120 successfully receives the RAR, the UE 120 may transmit a hybrid automatic repeat request (HARQ) ACK.

As shown by reference number 330 and/or 335, in the example of a four-step random access procedure, the network node 110 may transmit an RRC connection setup message. The RRC connection setup message may be referred to as message 4, msg4, MSG4, or a fourth message of a four-step random access procedure. In some aspects, the RRC connection setup message may include the detected UE identifier, a timing advance value, and/or contention resolution information.

As shown by reference number 340, if the UE 120 successfully receives the RRC connection setup message, the UE 120 may transmit a HARQ ACK. The UE 120 may transmit the HARQ-ACK message to indicate successful completion of the RACH procedure.

Low-tier UEs that may be associated with a reduced bandwidth reduction for baseband and/or radio frequency communications, an increased latency standard for baseband and/or radio frequency processing, and/or a half-duplex-only capability in some wireless communication systems for frequency division duplex communications and/or sub-band full duplex communications may be incompatible with some random access message resource allocations. In some aspects, in the absence of a priori knowledge of UE capabilities, the network node 110 may indicate frequency and/or time resource allocations during the RACH procedure that are incompatible with low-tier UEs. An incompatible resource allocation for an uplink random access message may result in the low-tier UE reinitiating the random access procedure, which may negatively affect latency and/or power consumption, and even still may not result in a successfully completed random access procedure because the network node 110 may continue to indicate incompatible resource allocations in the absence of information indicating the capabilities and/or category of the low-tier UE. In some aspects, while msg3 indication of UE capability may be enabled in some examples, the network node 110 may indicate resources for communicating the msg3, described in connection with reference number 310 and/or 315, that may be incompatible with the UE capabilities. Additionally, a UE capability indication using a dedicated PRACH resource pool may reduce trunking efficiency.

As indicated above, FIG. 3 is provided as an example. Other examples may differ from what is described with regard to FIG. 3.

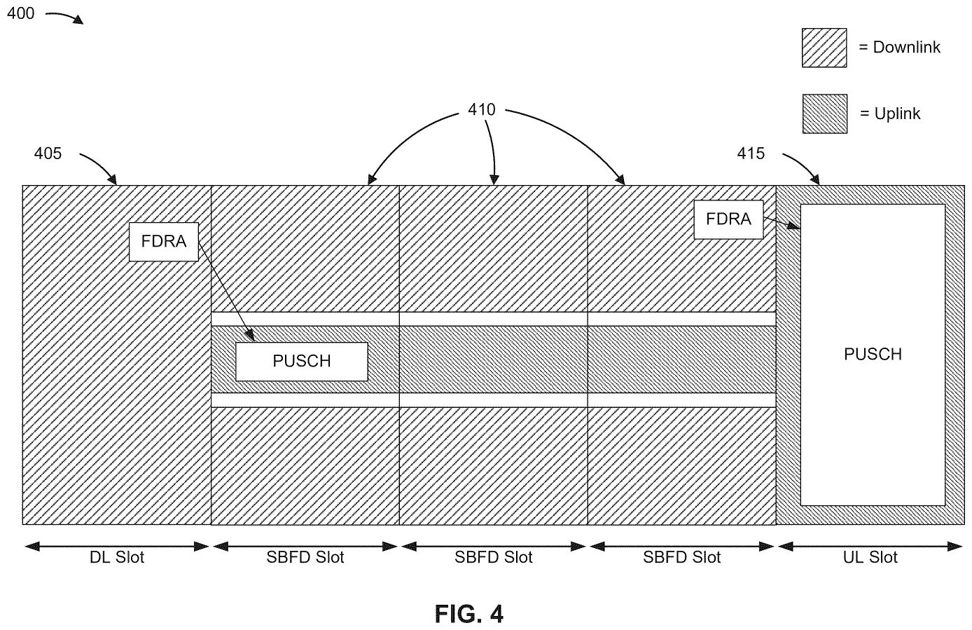

FIG. 4 is a diagram illustrating an example 400 of uplink frequency domain resource allocation (FDRA), in accordance with the present disclosure. The aspects described herein may also apply for downlink frequency domain resource allocation. The example 400 includes a depiction of three different types of slots: a downlink slot 405, three SBFD slots 410, and an uplink slot 415. In some aspects, an FDRA may be indicated via a control resource set downlink control information (DCI) or a higher layer configuration (e.g., RRC). In this example 400, the FDRA is indicated via a msg2 of a four-step random access procedure (e.g., a four-step contention-based random access procedure, such as the four-step RACH procedure described with reference to FIG. 3) and/or a msgB of a two-step random access procedure (e.g., a two-step contention-based random access procedure, such as the two-step RACH procedure described with reference to FIG. 3). In some aspects, the downlink slot 405 may include DCI granting uplink transmission and indicating an FDRA for transmission in an uplink sub-band (e.g., in the example of SBFD communications) of each of the SBFD slots 410, and/or indicating an FDRA for transmission of an uplink communication (e.g., msg3, PUSCH) in an uplink bandwidth part (BWP) of the uplink slot 415.

In some aspects, the FDRA may be associated with a resource allocation type, and the manner in which the FDRA is indicated may depend on the resource allocation type. In some aspects, using Type 0 resource allocation, consecutive RBs may be bundled into resource block groups (RBGs), and resources may be allocated in multiples of the RBGs. The sizes of the RBGs may depend on a size of the BWP of the slot in which the resources are allocated. In some aspects, each RBG may include 2, 4, 8, or 16 RBs. In one example Type 0 configuration, a BWP size of 1-36 RBs may result in 2 RBs per RBG, a BWP size of 37-72 RBs may result in 4 RBs per RBG, a BWP size of 73-144 RBs may result in 8 RBs per RBG, and a BWP size of 145-275 RBs may result in 16 RBs per RBG. The Type 0 configuration may be configured, in some aspects, via RRC signaling. In some aspects, the RBGs that are allocated via the FDRA may be indicated in a bitmap that maps to the RBGs of a slot. In some aspects, an 18-bit bitmap of “000011111111100000” may indicate that the 5th-13th RBGs are to be allocated.

For Type 1 resource allocation, one or more consecutive RBs are allocated based on an RB start parameter and a number of consecutive RBs within the BWP. In some aspects, a resource indicator value (RIV) may be included in DCI, and the RIV may indicate the RB starting point and the number of consecutive RBs. In some examples, the consecutive RBs may be considered an RBG and the RIV may include the starting RBG and number of RGBs. By way of example, an RIV may be calculated using the following formula:

$$if ( {L}_{RBs} - 1 ) \leq ⌊ {N}_{BWP}^{size} / 2 ⌋ then$$

$$RIV = {N}_{BWP}^{size} ( {L}_{RBs} - 1 ) + {RB}_{start}$$

$$else$$

$$RIV = {N}_{BWP}^{size} ( {N}_{BWP}^{size} - {L}_{RBs} + 1 ) + ( {N}_{BWP}^{size} - 1 - {RB}_{start} )$$

L_{RBs} indicates a quantity of RBs to be allocated. N_{BWP}^{size} indicates a size of the BWP (e.g., in total RBs). RBₛₜₐᵣₜ indicates the position at which the consecutive RB allocation begins. Based on the above formula, the RIV may be calculated (e.g., by a network node), such that a UE may determine, from the RIV, which resources to use for transmission/reception of one or more communications.

In some examples, the FDRA may indicate frequency resources that are at odds with a capability of the UE. In some aspects, in the absence of a priori knowledge of UE capability at a network node, the network node may indicate an FDRA that is incompatible with UEs having a reduced and/or different capability set (e.g., first or third category UEs, as described with reference to FIG. 1), such as low-tier UEs, than some other UEs (e.g., second category UEs, as described with reference to FIG. 1), such as high-tier UEs. As a result, an incompatible FDRA allocated to a low-tier UE during a RACH procedure may result in the low-tier UE reinitiating the RACH procedure, which may negatively affect latency and power consumption, and even still may not result in a successfully completed RACH procedure because the network node may continue to indicate incompatible FDRA resources in the absence of information indicating the capabilities and/or category of the low-tier UE.

As indicated above, FIG. 4 is provided as an example. Other examples may differ from what is described with respect to FIG. 4.

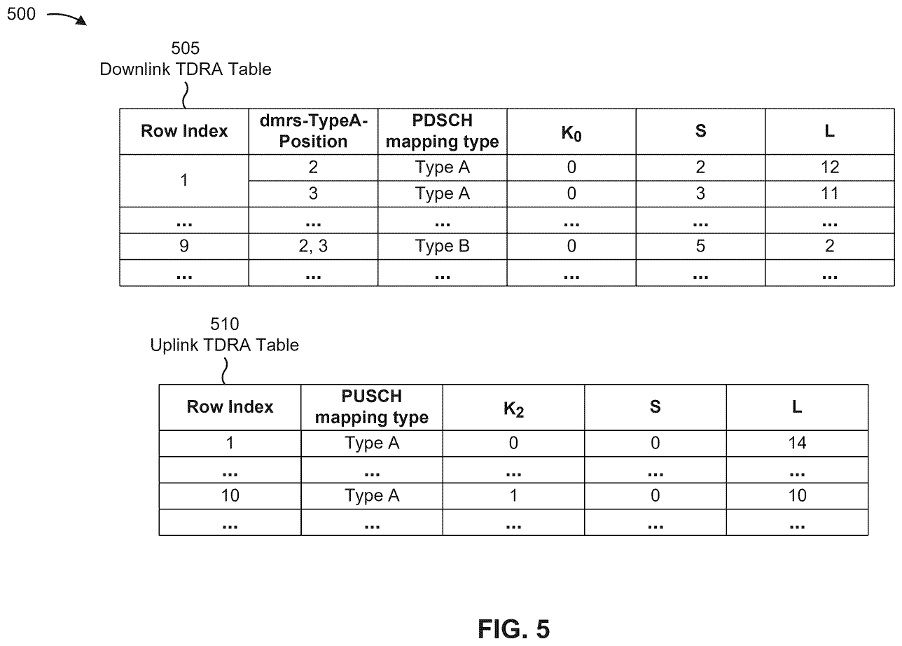

FIG. 5 is a diagram illustrating an example 500 of time domain resource allocations, in accordance with the present disclosure. FIG. 5 shows an example downlink time domain resource allocation (TDRA) table 505 and an example uplink TDRA table 510. The downlink TDRA table 505 may be, in some aspects, a physical downlink shared channel (PDSCH) TDRA table. The uplink TDRA table 510 may be, in some aspects, a physical uplink shared channel (PUSCH) TDRA table. In some aspects, the network node 110 and the UE 120 may use different TDRA tables than those shown in FIG. 5, such as for different configurations, different cells, and/or different sub-carrier spacings of cells.

When scheduling a communication, a network node 110 may transmit downlink control information (DCI) via a msg2 of a four-step random access procedure (e.g., a four-step contention-based random access procedure, such as the four-step RACH procedure described with reference to FIG. 3) and/or a msgB of a two-step random access procedure (e.g., a two-step contention-based random access procedure, such as the two-step RACH procedure described with reference to FIG. 3) that indicates a TDRA for uplink communication. In some aspects, the DCI may include a TDRA field that includes a TDRA index value. The TDRA index value may indicate a row index of a corresponding TDRA table, and the row index may correspond to a set of TDRA parameters (sometimes referred to as scheduling parameters or scheduling information). The network node 110 and the UE 120 may use those TDRA parameters for scheduled communications. In the examples shown in FIG. 5, a TDRA index value of m in the DCI may correspond to a row index of m+1 in the TDRA table. In some aspects, a TDRA index value of 0 may correspond to a row index of 1.

For a downlink communication (e.g., a PDSCH communication), the TDRA parameters may include, in some aspects, a K0 value, an S value, and an L value. The K0 value may represent a scheduling offset (e.g., in number of slots) between the slot containing the scheduling DCI (that schedules the downlink communication) and the slot containing the scheduled downlink communication (scheduled by the scheduling DCI). The S value may represent a starting symbol for the downlink communication in the indicated slot. The L value may represent a length (e.g., a number of consecutive symbols) of the downlink communication (e.g., in the indicated slot). In some aspects, the same row index value may correspond to a different set of TDRA parameters depending on a Type A demodulation reference signal (DMRS) position (e.g., a symbol within a resource block that contains the DMRS) and/or a PDSCH mapping type (e.g., indicating a starting symbol of the DMRS, a length of the DMRS, and/or whether slot-based scheduling or mini-slot-based scheduling is used).

For an uplink communication (e.g., a PUSCH communication), the TDRA parameters may include, in some aspects, a K2 value, an S value, and an L value. The K2 value may represent a scheduling offset (e.g., in number of slots) between the slot containing the scheduling DCI (that schedules the uplink communication) and the slot containing the scheduled uplink communication (scheduled by the scheduling DCI). The S value may represent a starting symbol for the uplink communication in the indicated slot. The L value may represent a length (e.g., a number of consecutive symbols) of the uplink communication (e.g., in the indicated slot). In some aspects, the same row index value may correspond to a different set of TDRA parameters depending on, in some aspects, an uplink mapping type (e.g., indicating a starting symbol of the DMRS, a length of the DMRS, and/or whether slot-based scheduling or mini-slot-based scheduling is used).

In some examples, the TDRA may indicate a timing offset (e.g., between a msg2/msgB and a msg3 and/or an uplink communication scheduled by the msg2/msgB) that is insufficient for radio frequency and/or baseband processing by the UE. In some aspects, in the absence of a priori knowledge of UE capability at a network node, the network node may indicate a timing offset that is incompatible with UEs having a reduced and/or different capability set (e.g., first or third category UEs, as described with reference to FIG. 1), such as low-tier UEs, as compared to some other UEs (e.g., second category UEs, as described with reference to FIG. 1), such as high-tier UEs. In some other examples, the timing offset may be insufficient due to unexpected BWP switching performed by the low-tier UE to adapt to an incompatible FDRA, as described with reference to FIG. 4. As a result, an insufficient timing offset may result in processing errors, and/or missed communications, among other examples, and may cause failure of the RACH procedure, in which case the low-tier UE may reinitiate the RACH procedure, negatively affecting latency and power consumption. However, reinitiating the RACH procedure may not result in a successfully completed RACH procedure because the network node may continue to indicate an insufficient timing offset in the absence of information indicating the capabilities and/or category of the low-tier UE, which may unnecessarily expend resources for little to no gain.

As indicated above, FIG. 5 is provided as an example. Other examples may differ from what is described with respect to FIG. 5.

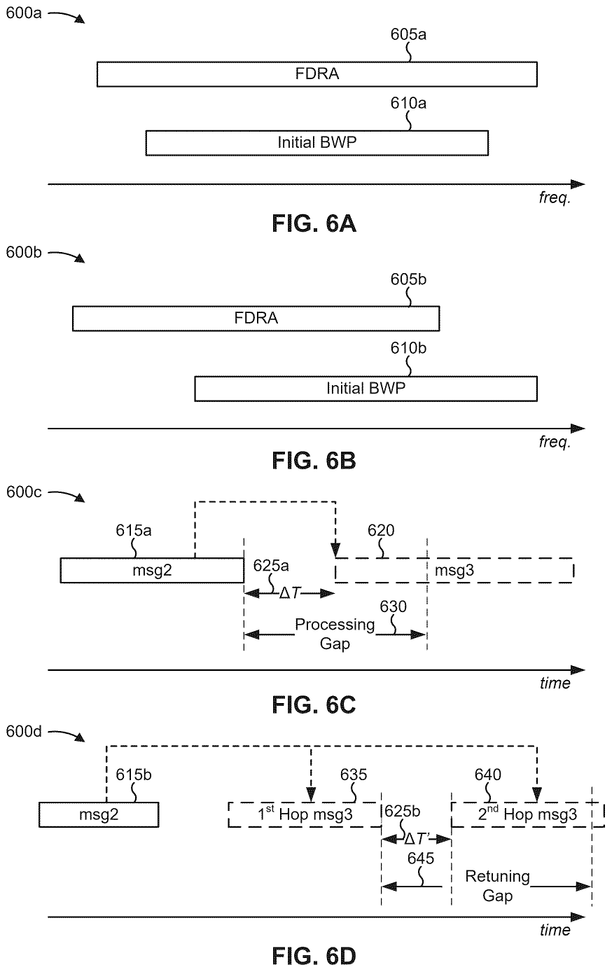

FIGS. 6A through 6D are diagrams illustrating example 600a, example 600b, example 600c, and example 600d, respectively, of FDRAs and/or TDRAs, in accordance with the present disclosure. As shown in FIGS. 6A and 6B, a low-tier UE (e.g., a low-tier UE as described herein, a UE 120 described in connection with FIGS. 1-5) may receive a misaligned and/or incompatible FDRA 605, indicated as part of a RACH procedure. In some aspects, in the absence of an early capability indication in msg1 of a RACH procedure (e.g., that indicates the capabilities of the UE), the low-tier UE may receive, from a network node (e.g., a network node 110 described in connection with FIGS. 1-7, a CU, a DU, and/or an RU), an uplink grant for msg3 of a RACH procedure, including an FDRA 605 for uplink communications (e.g., for communicating a msg3 of a RACH procedure as described with reference to FIGS. 3 and 4) that may be misaligned with the initial UL BWP 610 of the low-tier UE.

According to the example 600a, a UE may receive an FDRA 605a (e.g., in a msg2 and/or msgB of a RACH procedure) that is wider than an initial UL BWP 610a of the UE for uplink communications. In some aspects, the FDRA 605a may indicate a range of frequencies for transmitting a random access message to a network node that exceeds a frequency range capability of the UE. The FDRA 605a may include an upper frequency bound that is higher than an upper frequency bound of the initial UL BWP 610a, and may include a lower frequency bound that is lower than a lower frequency bound of the initial UL BWP 610a. In some examples, a frequency bandwidth (e.g., for uplink communications), indicated by the FDRA 605a, may exceed a maximum bandwidth capability of the low-tier UE and thus may be inadequate for RACH procedure communications between the low-tier UE and the network node.

As shown in FIG. 6B, a UE may receive an FDRA 605b that is misaligned with an initial UL BWP 610b of the UE for uplink communications. In some aspects, the FDRA 605b may indicate a range of frequencies for communicating with a network node that partially overlaps with a frequency range capability of the UE. The FDRA 605b may include an upper frequency bound that is lower than an upper frequency bound of the initial UL BWP 610b and may include a lower frequency bound that is lower than a lower frequency bound of the initial UL BWP 610b. In some examples, a frequency bandwidth (e.g., for uplink communications), indicated by the FDRA 605b, may exceed a maximum bandwidth capability of the low-tier UE and/or may be misaligned with an initial UL BWP of the low-tier UE, and thus may be incompatible with RACH procedure communications between the low-tier UE and the network node.

As shown in FIG. 6C, a UE may receive a random access message 615a, such as a msg2, that schedules and/or indicates a TDRA 620 including time resources for communicating an uplink RACH message (e.g., a msg3 of a RACH procedure). In some examples, the TDRA 620 may indicate a timing offset 625a (e.g., between the msg2 615a and the msg3 and/or an uplink communication scheduled by the msg2 615a) that is insufficient for radio frequency and/or baseband processing by the UE. In some aspects, in the absence of a priori knowledge of UE capability at a network node, the network node may indicate a timing offset 625a that is incompatible with UEs having a reduced and/or different capability set (e.g., first or third category UEs, as described with reference to FIG. 1), such as low-tier UEs, as compared to some other UEs (e.g., second category UEs, as described with reference to FIG. 1), such as high-tier UEs. In some other examples, the timing offset 625a may be insufficient due to unexpected BWP switching performed by the low-tier UE to adapt to an incompatible FDRA, as described with reference to FIG. 4. In some aspects, a processing gap 630 associated with a capability of the low-tier UE may be smaller than a timing offset indicated by the TDRA 620. As a result, an insufficient timing offset 625a may result in processing errors, and/or missed communications, among other examples, and may cause failure of the RACH procedure, in which case the low-tier UE may reinitiate the RACH procedure, negatively affecting latency and power consumption.

As shown in FIG. 6D, a UE may receive a random access message 615b, such as a msg2, that schedules and/or indicates a TDRA for a first frequency hop 635 and a second frequency hop 640, each including time resources for communicating a portion of an uplink RACH message (e.g., a msg3 of a RACH procedure). In some examples, the TDRA may indicate a timing offset 625b between the first frequency hop 635 and the second frequency hop 640 that is insufficient for retuning of the low-tier UE. In some aspects, in the absence of a priori knowledge of UE capability at a network node, the network node may indicate a timing offset 625a that is incompatible with UEs having a reduced and/or different capability set (e.g., first or third category UEs, as described with reference to FIG. 1), such as low-tier UEs, as compared to some other UEs (e.g., second category UEs, as described with reference to FIG. 1), such as high-tier UEs. In some other examples, the timing offset 625a may be insufficient due to unexpected BWP switching performed by the low-tier UE to adapt to an incompatible FDRA, as described with reference to FIG. 4. In some aspects, a retuning gap 645 associated with a capability of the low-tier UE to switch from communicating via a first frequency to a second frequency may be smaller than a timing offset indicated by the TDRA 620. As a result, an insufficient timing offset 625b may result in processing errors, and/or missed communications, among other examples, and may cause failure of the RACH procedure, in which case the low-tier UE may reinitiate the RACH procedure, negatively affecting latency and power consumption.

In some aspects, upon receiving an invalid (e.g., exceeding a UE capability) and/or incompatible UL grant that is not compatible with the reduced capabilities of the low-tier UE, the low-tier UE may refrain from transmitting an uplink random access message (e.g., msg3), even though the network node may be prepared to receive the uplink communication via the indicated frequency resources. In some examples, the UE may re-attempt and/or reinitiate the RACH procedure, which may increase the latency and power consumption of connecting to a wireless communication network. Additionally and/or alternatively, even if partial transmission is attempted by the low-tier UE, there may be a loss in performance and/or reliability, due to punctured REs that would be otherwise used for communicating DMRS and/or PUSCH. In some examples, when the network node fails to receive a msg3, the network node may retransmit the msg2/msgB, in some aspects, including with another invalid UL grant, and/or a new grant that will not be monitored by the low-tier UE because the low-tier UE may have transitioned to reinitiating the RACH procedure (e.g., retransmitting a msg1).

Solutions that rely on PRACH resource partitioning may not support the coexistence of different UE capabilities, may cause increased fragmentation of PRACH resources, and/or may not support dynamic prioritization of latency, coverage, signaling overhead reduction, and/or energy efficiency gains based on varying conditions and/or other communication stipulations.

As indicated above, FIG. 6 is provided as an example. Other examples may differ from what is described with respect to FIG. 6.

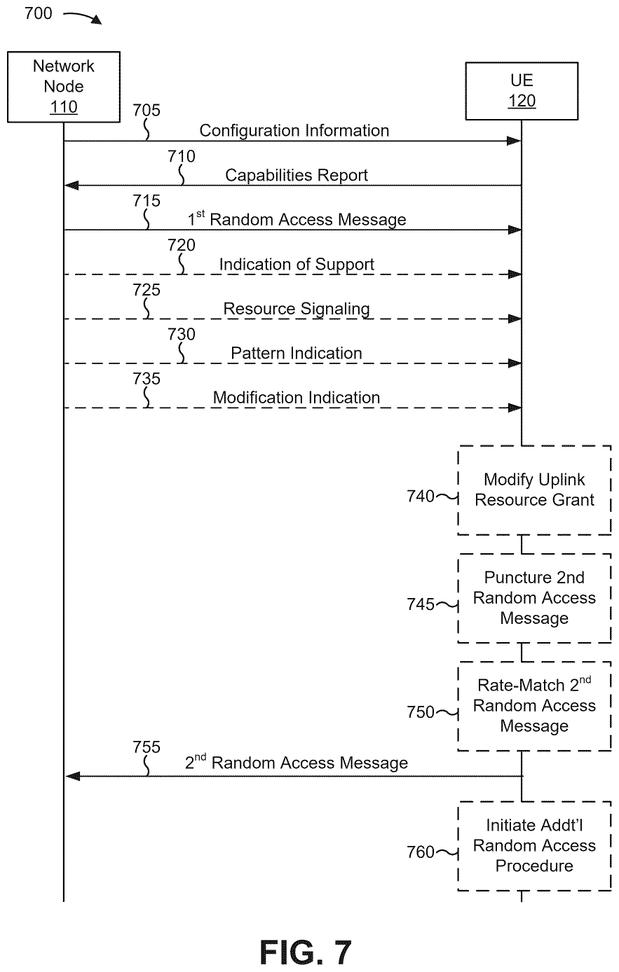

FIG. 7 is a diagram of an example 700 associated with random access message based indication of UE capabilities, in accordance with the present disclosure. As shown in FIG. 7, a network node 110 (e.g., network node 110 described in connection with FIGS. 1-3, a CU, a DU, and/or an RU) may communicate with a UE 120 (e.g., UE 120 described in connection with FIGS. 1-3). In some aspects, the network node 110 and the UE 120 may be part of a wireless network (e.g., wireless network 100). The UE 120 and the network node 110 may have established a wireless connection prior to operations shown in FIG. 7. In some aspects, the UE 120 may be an example of a low-tier UE as described herein, and with reference to FIGS. 1-6.

As will be described below, in some wireless communications systems, the network node 110 may indicate to the UE 120 that the network node 110 supports (e.g., indicated network node compatibility), enables (e.g., activates and/or indicates an optional action to be taken by the UE), and/or otherwise allows (e.g., removes one or more constraints) low-tier UEs (e.g., having reduced capabilities) to perform and/or initiate a random access procedure with the network node 110 while the UE 120 is in an RRC idle/inactive state. In some aspects, information regarding time resources and/or frequency resources via which the initial access is permitted to be performed may be broadcast (e.g., via SSB signaling and/or system information), and/or may be signaled via RRC signaling and/or MAC-CE signaling.

When the network node 110 supports the initial access of high-tier UEs and low-tier UEs via the same set of resources, the network node 110 may identify that the UE 120 is a low-tier UE during initial access, in some aspects, based at least on receiving a random access message (e.g., a msg3) from the UE 120. The UE 120 may transmit a random access message (e.g., msg3) transmission including an initial transmission and/or a re-transmission of a PUSCH message, which may be triggered by receiving a previous random access message (e.g., msg2 of a four-step contention-based random access procedure, and/or at least a portion of a msgB of a two-step contention-based random access procedure).

The identification of a low-tier UE may be achieved by the network node 110, in some aspects, via receiving an explicit and/or an implicit indication of the UE capabilities via a random access message (e.g., in msg3). The low-tier UE 120 may transmit the explicit indication via a special access identifier in the payload of the random access message (e.g., which may be different from a logical channel identifier associated with RedCap UEs in some wireless communication systems), which may be specified via wireless communication standards and/or may be configured by the network node 110 (e.g., via control signaling). The implicit indication may include an interleaving, scrambling, cyclic redundancy check (CRC), and/or DMRS pattern for transmission of the random access message (e.g., msg3), and/or may include a modified random access message (e.g., msg3) transmission based on an adapted UL grant. The patterns of interleaving, scrambling, CRC, and/or DMRS transmission for implicitly indicating a capability level of the UE 120 may be specified via wireless communication standards and/or may be configured by the network node 110 (e.g., via control signaling, system information), and/or signaled via an uplink grant.

If the network node 110 supports msg3-based identification of low-tier UEs, the network node 110 may indicate an option for the UE 120 to validate the uplink grant for transmitting the msg3. In some aspects, a low-tier UE may not be expected to receive an invalid UL grant for msg3 transmission (and/or the network node 110 may issue a UL grant valid for all UE types). As a result, the FDRAs and/or the TDRAs described with reference to FIG. 6 may be treated as invalid by the UE 120. In such aspects, the UE 120 may re-attempt to perform a random access procedure when an error case is identified. In some other aspects, when a low-tier UE receives an uplink grant that is incompatible with the reduced UE capabilities, the UE 120 may be supported, enabled, and/or allowed to perform uplink grant adaptation, and/or may transmit the random access message (e.g., msg3) via the adapted grant. In such aspects, the UE 120 may adapt the uplink grant for the random access message (e.g., msg3) transmission, according to one or more rules specified by wireless communications standards, and/or configured by the network node 110. In some aspects, when the random access message transmission and/or retransmissions via the adapted uplink grant fail, the low-tier UE may re-attempt to perform the random access procedure.

As a result, and as will be discussed in further detail below, random access message based indication of UE capabilities may facilitate the coexistence of UEs having different capabilities.

As shown by reference number 705, the network node 110 may transmit, and the UE 120 may receive, configuration information. In some aspects, the UE 120 may receive the configuration information via one or more of system information (e.g., a master information block (MIB) and/or a system information block (SIB), among other examples), RRC signaling, one or more MAC-CEs, and/or DCI, among other examples.

In some aspects, the configuration information may indicate one or more candidate configurations and/or communication parameters. In some aspects, the one or more candidate configurations and/or communication parameters may be selected, activated, and/or deactivated by a subsequent indication. In some aspects, the subsequent indication may indicate a candidate configuration and/or communication parameter from the one or more candidate configurations and/or communication parameters. In some aspects, the subsequent indication (e.g., an indication described herein) may include a dynamic indication, such as one or more MAC CEs and/or one or more DCI messages, among other examples.

In some aspects, the configuration information may enable the UE 120 to perform a random access procedure with the network node 110. In some aspects, the configuration information may include information regarding time resources and/or frequency resources via which the initial access is permitted to be performed by the UE 120. In some aspects, the configuration information may prompt the UE 120 to perform grant validation and/or indicate a capability level of the UE 120.

The UE 120 may configure itself based at least in part on the configuration information. In some aspects, the UE 120 may be configured to perform one or more operations described herein based at least in part on the configuration information.

As shown by reference number 710, the UE 120 may transmit, and the network node 110 may receive, a capabilities report. The capabilities report may indicate whether the UE 120 supports a feature and/or one or more parameters related to the feature. In some aspects, the capability information may indicate a capability and/or parameter for random access message based indication of UE capabilities. As another example, the capabilities report may indicate a capability and/or parameter for grant validation according to UE capability. One or more operations described herein may be based on capability information of the capabilities report. In some aspects, the UE 120 may perform a communication in accordance with the capability information, or may receive configuration information that is in accordance with the capability information. In some aspects, the capabilities report may indicate UE support for grant adaptation and/or modification.

In some aspects, the configuration information described in connection with reference number 705 and/or the capabilities report described in connection with reference number 710 may include information transmitted via multiple communications. Additionally, or alternatively, the network node 110 may transmit the configuration information, or a communication including at least a portion of the configuration information, before and/or after the UE 120 transmits the capabilities report. In some aspects, the network node 110 may transmit a first portion of the configuration information before the capabilities report, the UE 120 may transmit at least a portion of the capabilities report, and the network node 110 may transmit a second portion of the configuration information after receiving the capabilities report.

As shown by reference number 715, the network node 110 may transmit, and the UE 120 may receive, a first random access message. In some aspects, the UE 120 may receive, from the network node 110 via the first random access message (e.g., msg2) as part of a random access procedure, an uplink resource grant (e.g., including FDRA and/or TDRA) associated with a first set of capabilities (e.g., second category capabilities as described with reference to FIG. 1). In some aspects, the UE 120 may be associated with a second set of capabilities (e.g., first and/or third category capabilities as described with reference to FIG. 1). In some aspects, the second set of capabilities may include a reduced set of capabilities with respect to the first set of capabilities. In some aspects, the second set of capabilities may include a reduced bandwidth capability (e.g., UEs in the second category may be enabled to communicate over a larger bandwidth than UEs in the first and/or third categories), a reduced latency capability (e.g., the capability of the UE 120 to meet latency standards and/or requirements may be less than other UEs), and/or a half-duplex communications capability (e.g., the UE 120 may be enabled for half-duplex-only communications in some scenarios).

In some aspects, the uplink resource grant may include a set of patterns for indicating the second set of capabilities.

As shown by reference number 720, in some aspects, the network node 110 may transmit, and the UE 120 may receive, an indication of support for initial access communications with the UE 120 according to the second set of capabilities. In some aspects, the UE 120 may receive an indication that the network node 110 supports initial access communications with the UE 120 according to the second set of capabilities. The network node 110 may indicate that the network node 110 supports and/or allows low-tier UEs having reduced capabilities to access the network from the idle/inactive state.

As shown by reference number 725, in some aspects, the network node 110 may transmit, and the UE 120 may receive, signaling indicating a set of time-frequency resources for which the random access procedure is enabled for the UE 120. In some aspects, the UE 120 may receive signaling indicating a set of time-frequency resources for which the random access procedure is enabled for the UE 120 in association with the UE 120 being associated with the second set of capabilities. The network node 110 may transmit information including an indication of time interval(s) and/or frequencies via which the initial access procedure is allowed to be performed. In some aspects, the signaling may include SSB signaling, SIB signaling, RRC signaling, and/or MAC-CE signaling. In some aspects, the signaling may be the same as, may include, and/or may be part of the configuration described in connection with reference number 705.

As shown by reference number 730, in some aspects, the network node 110 may transmit, and the UE 120 may receive, a message including a set of patterns for indicating the second set of capabilities. In some aspects, the UE 120 may receive a message (e.g., via system information) including a set of patterns for indicating the second set of capabilities. In some other aspects, the set of patterns may be defined via one or more wireless communication standards.

As shown by reference number 735, in some aspects, the network node 110 may transmit, and the UE 120 may receive, an indication that enables the UE 120 to modify the uplink resource grant. In some aspects, the UE 120 may receive an indication that enables the UE 120 to modify the uplink resource grant to include frequency resources indicated by the uplink resource grant (e.g., FDRA) that overlap in a frequency domain with a set of frequency resources (e.g., an initial UL BWP) associated with the UE 120.

In some aspects, the UE 120 may receive an indication that enables the UE 120 to modify the uplink resource grant to omit one or more time resources (e.g., from a TDRA), including a first-occurring time resource, indicated by the uplink resource grant to obtain a subset of time resources. In such aspects, a time offset between the first random access message (e.g., msg2) and the first-occurring time resource (e.g., first resource of TDRA for msg3 transmission) may be less than a time offset for the UE to switch from communicating via a first frequency range to a second frequency range (e.g., BWP switching) and/or may be less than a radio frequency and/or baseband processing time associated with the capabilities of the UE 120. In some aspects, one or more reference signals may be scheduled for transmission via at least one time resource subsequent to the first-occurring time resource in association with omitting the one or more time resources. DMRS for msg3 may not be scheduled within a quantity of time resources (e.g., symbols) canceled by the UE 120.

In some aspects, the UE 120 may receive an indication that enables the UE 120 to modify the uplink resource grant to omit one or more time resources associated with a first frequency hop and/or a second frequency hop. In such aspects, a time offset between the first frequency hop and the second frequency hops may be less than a retuning gap associated with the UE 120 and/or the capabilities of the UE 120.

As shown by reference number 740, in some aspects, the UE 120 may modify the uplink resource grant. In some aspects, the UE 120 may modify the uplink resource grant to obtain the modified uplink resource grant in association with the second random access message including a msg3 of the random access procedure. When the low-tier UE 120 receives an uplink grant that is incompatible with the UE capabilities, the UE 120 may be allowed to perform uplink grant adaptation for transmitting the msg3.

As shown by reference number 745, in some aspects, the UE 120 may puncture one or more frequency resources for transmitting the second random access message. In some aspects, the UE 120 may puncture the second random access message via the modified uplink resource grant that includes a subset of frequency resources indicated by the uplink resource grant (e.g., in association with receiving the modification indication described in connection with reference number 735). In such aspects, the set of frequency resources associated with the UE 120 may include the subset of frequency resources.

As shown by reference number 750, in some aspects, the UE 120 may rate-match the second random access message. In some aspects, the UE 120 may rate-match the second random access message via the modified uplink resource grant that includes a subset of frequency resources indicated by the uplink resource grant (e.g., in association with receiving the modification indication described in connection with reference number 735). In such aspects, the set of frequency resources associated with the UE 120 may include the subset of frequency resources. In some aspects, the UE 120 may receive an indication that enables the UE 120 to modify the uplink resource grant to include one or more frequency hops that overlap in the frequency domain with a set of frequency resources (e.g., FDRA) indicated by the uplink resource grant.

In some aspects, the UE 120 may rate-match the second random access message via the modified uplink resource grant that includes the subset of time resources in association with omitting the one or more time resources, described in connection with reference number 735.

As shown by reference number 755, the UE 120 may transmit, and the network node 110 may receive, the second random access message. In some aspects, the UE 120 may transmit, via the modified uplink resource grant, a second random access message (e.g., msg3) in accordance with identifying that the uplink resource grant is incompatible with the second set of capabilities. In some aspects, the UE 120 may transmit the second random access message including an indication of the second set of capabilities. In such aspects, the modified uplink resource grant may at least partially overlap in time and/or frequency with a resource grant for communications at an additional UE that is associated with the first set of capabilities. The network node 110 may identify the UE 120 as a low-tier UE based at least on receiving the msg3 from the low-tier UE 120 and/or may support initial access of second category UEs and low-tier UEs via the same set of resources. In such aspects, the network node 110 may transmit, to an additional UE, via a third random access message (e.g., an additional msg2), an additional uplink resource grant including a set of frequency resources that is multiplexed with the set of frequency resources in the uplink resource grant, and that is smaller than a set of frequency resources associated with at least one of the UE 120 or the additional UE (e.g., smaller than the initial UL BWP of the UE 120 and/or the additional UE).

In some aspects, the indication may include a special access identifier. In some aspects, the second random access message may include an initial uplink data channel message, and/or a retransmitted uplink data channel message. In some aspects, transmitting the second random access message may be triggered by receiving the first random access message. In some aspects, transmitting the second random access message via the modified uplink resource grant indicates that the UE 120 is associated with the second set of capabilities.

In some aspects, the UE 120 may transmit the second random access message via the one or more frequency hops. In such aspects, the set of frequency resources indicated by the uplink resource grant may be different from a set of frequency resources associated with the UE (e.g., initial UL BWP). In some aspects, the UE 120 may transmit a third random access message via a first set of frequency resources (e.g., initial UL BWP) associated with the UE 120 and/or may receive the first random access message via the first set of frequency resources- and may transmit the second random access message via a second set of frequency resources, indicated by the uplink resource grant, in association with switching from communicating via the first set of frequency resources to communicating using the second set of frequency resources. In such aspects, the second set of frequency resources (e.g., FDRA) may include a subset of the first set of frequency resources. The FDRA may be indicated to be within any portion of the initial UL BWP. In some aspects, the modified uplink resource grant may include the second set of frequency resources in association with the UE 120 being associated with the second set of capabilities.

In some aspects, the indication may include an interleaving pattern associated with the second set of capabilities, a scrambling pattern associated with the second set of capabilities, a CRC algorithm associated with the second set of capabilities, and/or a DMRS associated with the second set of capabilities.

In some aspects, a set of frequency resources indicated by the uplink resource grant may be larger than a set of frequency resources associated with the UE 120 (e.g., initial UL BWP), and the UE 120 may refrain from transmitting the second random access message via the set of frequency resources (e.g., FDRA) indicated by the uplink resource grant.

In some aspects, the UE 120 may transmit the second random access message via the modified uplink resource grant including one or more of a set of time resources associated with the first frequency hop, a set of time resources associated with the second frequency hop, a subset of time resources associated with the first frequency hop, or a subset of resources associated with the second frequency hop, in association with receiving the indication that enabled the UE 120 to modify the uplink resource grant to omit one or more time resources associated with the first frequency hop or the second frequency hop, as described in connection with reference number 735.

As shown by reference number 760, in some aspects, the UE 120 may initiate a second random access procedure. In some aspects, the UE 120 may initiate an additional random access procedure in association with identifying that transmitting the second random access message via the modified uplink resource grant failed. When msg3 transmission (and/or re-transmissions) via the modified uplink resource grant fails, the low-tier UE 120 may re-attempt to perform a RACH procedure (e.g., as described with reference to FIG. 3).

As indicated above, FIG. 7 is provided as an example. Other examples may differ from what is described with respect to FIG. 7.

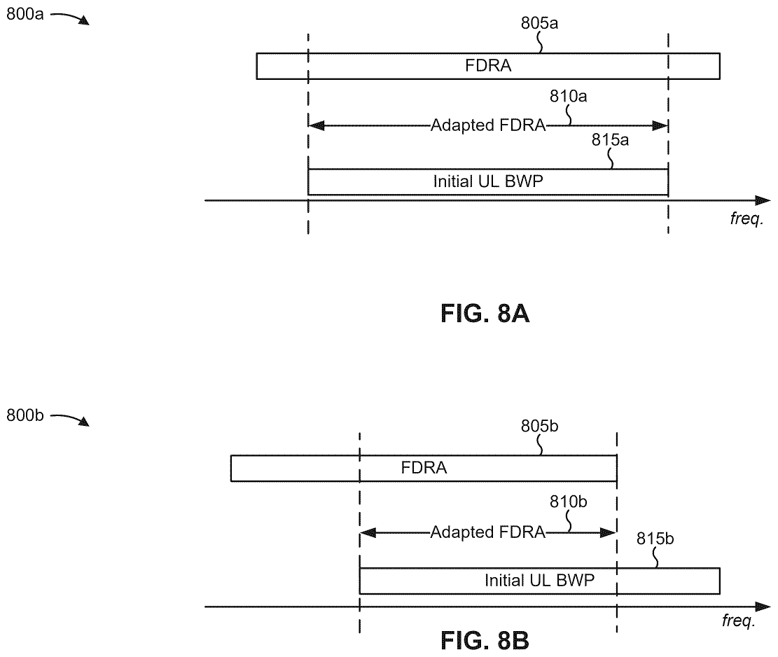

FIG. 8A is a diagram illustrating an example 800a of an adapted FDRA, in accordance with the present disclosure. FIG. 8B is a diagram illustrating an example 800b of an adapted FDRA, in accordance with the present disclosure. As shown in FIGS. 8A and 8B, a low-tier UE (e.g., a low-tier UE as described herein, a UE 120 described in connection with FIGS. 1-7) may perform grant adaptation for a misaligned FDRA 805 that was indicated as part of a RACH procedure. In some aspects, in the absence of an early capability indication in msg1 of a RACH procedure (e.g., that indicates the capabilities of the UE), the low-tier UE may receive, from a network node (e.g., a network node 110 described in connection with FIGS. 1-7, a CU, a DU, and/or an RU), an uplink grant for msg3 of a RACH procedure, including an FDRA 805 for uplink communications (e.g., for communicating a msg3 of a RACH procedure as described with reference to FIGS. 3, 4, and 7) that may be misaligned with the initial UL BWP 815 of the low-tier UE.

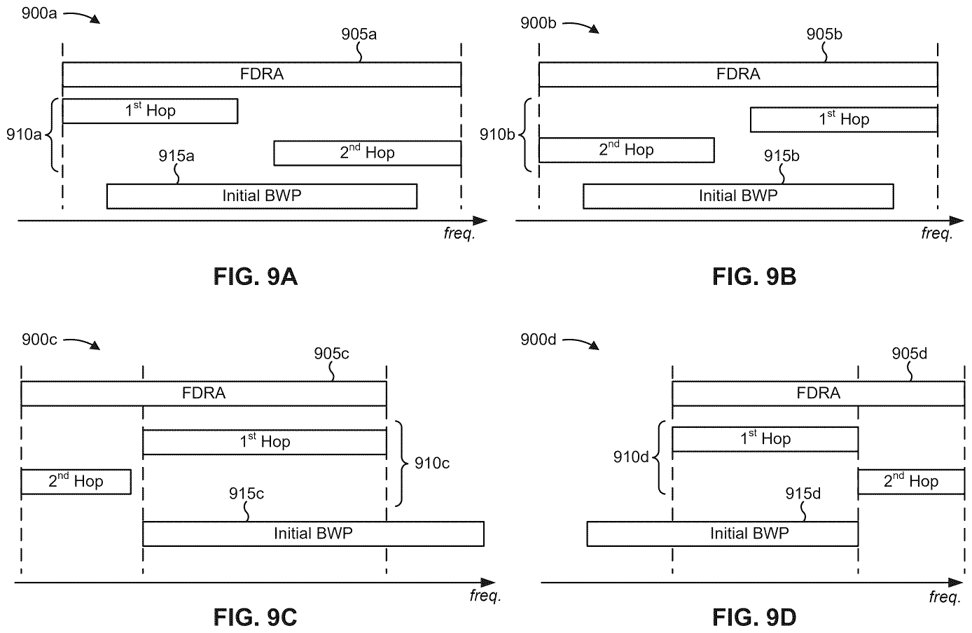

The network node may transmit signaling that indicates support for (e.g., indicates network node compatibility), enables (e.g., activates and/or indicates an optional action to be taken by the UE), and/or otherwise allows (e.g., removes one or more constraints of) the UE to adapt the FDRA 805 to obtain an adapted FDRA 810. In some aspects, according to the signaling, the UE may (e.g., may be supported to, may be allowed to, may be indicated to) puncture one or more frequency resources (e.g., one or more REs) indicated by the FDRA 805 that are without the initial UL BWP 815. In such aspects, the UE may transmit an uplink communication (e.g., including a msg3) via one or more resource elements that intersect with the initial UL BWP 815 without rate-matching the uplink communication. In some aspects, the UE may truncate the uplink communication and/or omit one or more bits of the uplink communication to communicate the uplink communication via the adapted FDRA 810, which may be narrower than the FDRA 805. In some aspects, the UE may (e.g., may be supported to, may be allowed to, may be indicated to) transmit and rate-match the uplink communication (e.g., including a msg3) via one or more resource elements that intersect with the initial UL BWP 815. In some aspects, the UE may refrain from transmitting via the frequency resources of the FDRA 805 that do not overlap with the initial UL BWP 815, and may adjust the uplink communication to meet the capacity of the adapted FDRA 810, which may be narrower than the FDRA 805, by adjusting the MCS of the uplink communication. In some aspects, the UE may (e.g., may be supported to, may be allowed to, may be indicated to) switch to frequency hopping, and may transmit the uplink communication (e.g., including a msg3) across the frequency range indicated by the FDRA 805 (e.g., as further described with reference to FIGS. 9A through 9D). In some aspects, the UE may communicate the msg 1 and/or the msg2 without performing frequency hopping and may perform frequency hopping for communicating the msg3.

As shown in FIG. 8A, a UE may receive an FDRA 805a that is wider than an initial UL BWP 815a of the UE for uplink communications, as described with reference to FIG. 6A. In some aspects, the FDRA 805a may indicate a range of frequencies for communicating with a network node that exceeds a frequency range capability of the UE. The FDRA 805a may include an upper frequency bound that is higher than an upper frequency bound of the initial UL BWP 815a and may include a lower frequency bound that is lower than a lower frequency bound of the initial UL BWP 815a. In such aspects, the UE may adapt the FDRA 805a by communicating via the frequency resources that overlap between the FDRA 805a and the initial UL BWP 815a and/or by puncturing the frequency resources that do not overlap between the FDRA 805a and the initial UL BWP 815a. In such aspects, the adapted FDRA 810a may include all of the frequency resources of the initial UL BWP 815a. In the example 800a, the UE may, or may not, transmit the uplink communication, including a RACH message, by rate-matching the data bits of the uplink communications over the frequency resources of the adapted FDRA 810a.

As shown in FIG. 8B, a UE may receive an FDRA 805b that is misaligned with an initial UL BWP 815b of the UE for uplink communications, as described with reference to FIG. 6B. In some aspects, the FDRA 805b may indicate a range of frequencies for communicating with a network node that partially overlaps with a frequency range capability of the UE. The FDRA 805b may include an upper frequency bound that is lower than an upper frequency bound of the initial UL BWP 815b, and may include a lower frequency bound that is lower than a lower frequency bound of the initial UL BWP 815b. In such aspects, the UE may adapt the FDRA 805b by communicating via the frequency resources that overlap between the FDRA 805b and the initial UL BWP 815b, and/or by puncturing the frequency resources that do not overlap between the FDRA 805a and the initial UL BWP 815a. In such aspects, the adapted FDRA 810b may include a portion of the frequency resources of the initial UL BWP 815b. In the example 800b, the UE may, or may not, transmit the uplink communication, including a RACH message, by rate-matching the data bits of the uplink communications over the frequency resources of the adapted FDRA 810b.

As indicated above, FIGS. 8A and 8B are provided as examples. Other examples may differ from what is described with respect to FIGS. 8A and 8B.

FIGS. 9A through 9D are diagrams illustrating example 900a, example 900b, example 900c, and example 900d, respectively, of adapted FDRAs including one or more frequency hops, in accordance with the present disclosure. As shown in FIG. 9, a low-tier UE (e.g., a low-tier UE as described herein, a UE 120 described in connection with FIGS. 1-7) may perform grant adaptation for a misaligned FDRA 905 indicated as part of a RACH procedure. In some aspects, in the absence of an early capability indication in msg1 of a RACH procedure (e.g., that indicates the capabilities of the UE), the low-tier UE may receive, from a network node (e.g., a network node 110 described in connection with FIGS. 1-7, a CU, a DU, and/or an RU), an uplink grant for msg3 of a RACH procedure, including an FDRA 905 for uplink communications (e.g., for communicating a msg3 of a RACH procedure as described with reference to FIGS. 3, 4, and 7) that may be misaligned with the initial UL BWP 915 of the low-tier UE.

The network node may transmit signaling that indicates support for (e.g., indicated network node compatibility), enables (e.g., activates and/or indicates an optional action to be taken by the UE), and/or otherwise allows (e.g., removes one or more constraints) the UE to adapt the FDRA to obtain an adapted FDRA 910, that includes one or more frequency hops. In some aspects, according to the signaling, the UE may (e.g., may be supported to, may be allowed to, may be indicated to) switch to frequency hopping, and may transmit the uplink communication (e.g., including a msg3) across the frequency range indicated by the FDRA 805 (e.g., as further described with reference to FIG. 9) via one or more frequency hops. In some aspects, the UE may communicate the msg 1 and/or the msg2 without performing frequency hopping and may perform frequency hopping for communicating the msg3.

As shown in FIG. 9A, a UE may receive an FDRA 905a that is wider than an initial UL BWP 915a of the UE for uplink communications, as described with reference to FIG. 6A. In some aspects, the FDRA 905a may indicate a range of frequencies for communicating with a network node that exceeds a frequency range capability of the UE. The FDRA 905a may include an upper frequency bound that is higher than an upper frequency bound of the initial UL BWP 915a, and may include a lower frequency bound that is lower than a lower frequency bound of the initial UL BWP 915a. In such aspects, the UE may adapt the FDRA 905a by communicating via the frequency resources of the FDRA 905a using a first frequency hop and a second frequency hop. In such aspects, the adapted FDRA 910a may include frequency resources that do not overlap with the initial UL BWP 915a and may include most and/or all of the resources included in the initial UL BWP 915d. In some aspects, the first frequency hop may include a lower frequency range portion of the frequency resources indicated by the FDRA 905a, which may include some resources that overlap between the FDRA 905a and the initial UL BWP 915a, and/or may include some resources that are included in the FDRA 905a and do not overlap with frequency resources lower than a lower bound of the initial UL BWP 915a. The second frequency hop may include a higher frequency range portion of the frequency resources indicated by the FDRA 905a, which may include some resources that overlap between the FDRA 905a and the initial UL BWP 915a and/or may include some resources that are included in the FDRA 905a and do not overlap with frequency resources exceeding an upper bound of the initial UL BWP 915a. In the example 900a, the UE may transmit the uplink communication, including a RACH message, without rate-matching the data bits of the uplink communications over the frequency resources of the adapted FDRA 910a because the frequency resources of the adapted FDRA 910a may be sufficient for transmitting the msg3 without puncturing and/or rate-matching.

As shown in FIG. 9B, a UE may receive an FDRA 905b that is wider than an initial UL BWP 915b of the UE for uplink communications, as described, in some aspects, with reference to FIG. 6A. In some aspects, the FDRA 905b may indicate a range of frequencies for communicating with a network node that exceeds a frequency range capability of the UE. The FDRA 905b may include an upper frequency bound that is higher than an upper frequency bound of the initial UL BWP 915b, and may include a lower frequency bound that is lower than a lower frequency bound of the initial UL BWP 915b. In such aspects, the UE may adapt the FDRA 905b by communicating via the frequency resources of the FDRA 905b using a first frequency hop and a second frequency hop. In such aspects, the adapted FDRA 910b may include frequency resources that do not overlap with the initial UL BWP 915b and may include most and/or all of the resources included in the initial UL BWP 915d. In some aspects, the first frequency hop may include a higher frequency range portion of the frequency resources indicated by the FDRA 905b, which may include some resources that overlap between the FDRA 905b and the initial UL BWP 915b and/or may include some resources that are included in the FDRA 905b and do not overlap with frequency resources higher than an upper bound of the initial UL BWP 915b. The second frequency hop may include a lower frequency range portion of the frequency resources indicated by the FDRA 905b, which may include some resources that overlap between the FDRA 905b and the initial UL BWP 915b and/or may include some resources that are included in the FDRA 905b and do not overlap with frequency resources lower than a lower bound of the initial UL BWP 915b. In the example 900b, the UE may transmit the uplink communication, including a RACH message, without rate-matching the data bits of the uplink communications over the frequency resources of the adapted FDRA 910b because the frequency resources of the adapted FDRA 910b may be sufficient for transmitting the msg3 without puncturing and/or rate-matching.

As shown in FIG. 9C, a UE may receive an FDRA 905c that is misaligned with an initial UL BWP 915c of the UE for uplink communications, as described with reference to FIG. 6B. In some aspects, the FDRA 905c may indicate a range of frequencies for communicating with a network node that partially overlaps with a frequency range capability of the UE. The FDRA 905c may include an upper frequency bound that is lower than an upper frequency bound of the initial UL BWP 915c and may include a lower frequency bound that is lower than a lower frequency bound of the initial UL BWP 915c. In such aspects, the adapted FDRA 910c may include frequency resources that do not overlap with the initial UL BWP 915c and may omit some resources included in the initial UL BWP 915c. In some aspects, the first frequency hop may include a higher frequency range portion of the frequency resources indicated by the FDRA 905c, which may include resources that overlap between the FDRA 905c and the initial UL BWP 915c and/or may not include some resources that are included in the initial UL BWP 915c and do not overlap with frequency resources higher than an upper bound of the FDRA 905c. The second frequency hop may include a lower frequency range portion of the frequency resources indicated by the FDRA 905c, which may include resources that do not overlap with the initial UL BWP 915c. In the example 900c, the UE may transmit the uplink communication, including a RACH message, without rate-matching the data bits of the uplink communications over the frequency resources of the adapted FDRA 910c because the frequency resources of the adapted FDRA 910c may be sufficient for transmitting the msg3 without puncturing and/or rate-matching.

As shown in FIG. 9D, a UE may receive an FDRA 905d that is misaligned with an initial UL BWP 915d of the UE for uplink communications, as described with reference to FIG. 6B. In some aspects, the FDRA 905d may indicate a range of frequencies for communicating with a network node that partially overlaps with a frequency range capability of the UE. The FDRA 905d may include an upper frequency bound that is higher than an upper frequency bound of the initial UL BWP 915d and may include a lower frequency bound that is higher than a lower frequency bound of the initial UL BWP 915d. In such aspects, the adapted FDRA 910d may include frequency resources that do not overlap with the initial UL BWP 915d and may omit some resources included in the initial UL BWP 915d. In some aspects, the first frequency hop may include a lower frequency range portion of the frequency resources indicated by the FDRA 905d, which may include resources that overlap between the FDRA 905d and the initial UL BWP 915d, and/or may not include some resources that are included in the initial UL BWP 915d and do not overlap with frequency resources lower than a lower bound of the FDRA 905d. The second frequency hop may include a higher frequency range portion of the frequency resources indicated by the FDRA 905d, which may include resources that do not overlap with the initial UL BWP 915d. In the example 900d, the UE may transmit the uplink communication, including a RACH message, without rate-matching the data bits of the uplink communications over the frequency resources of the adapted FDRA 910c because the frequency resources of the adapted FDRA 910c may be sufficient for transmitting the msg3 without puncturing and/or rate-matching.

In the examples 900a, 900b, 900c, and 900d, the first hop and the second hop of the respective adapted FDRA 910 may span an entirety of the frequency resources indicated by the corresponding FDRA 905. In some other aspects, the first hop and the second hop of the respective adapted FDRA 910 may span a majority portion of the frequency resources indicated by the corresponding FDRA 905a and/or FDRA 905b. In some aspects, one or more resources between the first frequency hop and the second frequency hop may be punctured and/or otherwise omitted from transmission of the uplink communication. Additionally or alternatively, the frequency order of the hopping and/or the bandwidth of each hop may be selected and/or determined based on one or more specifications (e.g., such as 3GPP wireless communication specifications) and/or may be configured by the network node (e.g., via control signaling and/or random access signaling).

As indicated above, FIGS. 9A through 9D are provided as examples. Other examples may differ from what is described with respect to FIGS. 9A through 9D.

In some aspects, the network node may indicate a msg3 resource allocation in which the FDRA bandwidth is within an UL transmission bandwidth capability of the low-tier UE (e.g., 5 MHz), but may not limit where the FDRA is within the initial UL BWP of the low-tier UE. In some aspects, the FDRA may be anywhere within the initial UL BWP of the low-tier UE (e.g., may not be centrally aligned with the initial UL BWP). As a result, the low-tier UE may not expect the indicated FDRA for communicating the uplink communication (e.g., including the msg3) to include a frequency range that is wider than a capability of the UE, and/or the low-tier UE may ignore the FDRA (e.g., msg3 UL grant), and/or may generate the uplink communication (e.g., PUSCH, msg3) using puncturing. Defining the FDRA to be valid when narrower and within an initial UL BWP of the low-tier UE may facilitate the scheduling, by the network node, of a first UE in a first frequency range (e.g., such as 5 MHz), a second UE in a second frequency range (e.g., such as a second 5 MHz), and so on, for frequency division multiplexing UL communications from a plurality of UEs (e.g., including one or more low-tier UEs). In such aspects, the UE may be implicitly prompted to perform BWP switching given such an allocated FDRA. In some aspects, the center alignment of the DL and/or UL BWP of the low-tier UE may be relaxed if the BWP used for the UL communication (e.g., to transmit the msg3) is considered temporary. By considering the BWP to be temporary, the UE may return to communicating using the initial UL BWP after communicating the uplink communication, which may decrease latency costs and complexity associated with BWP switching.

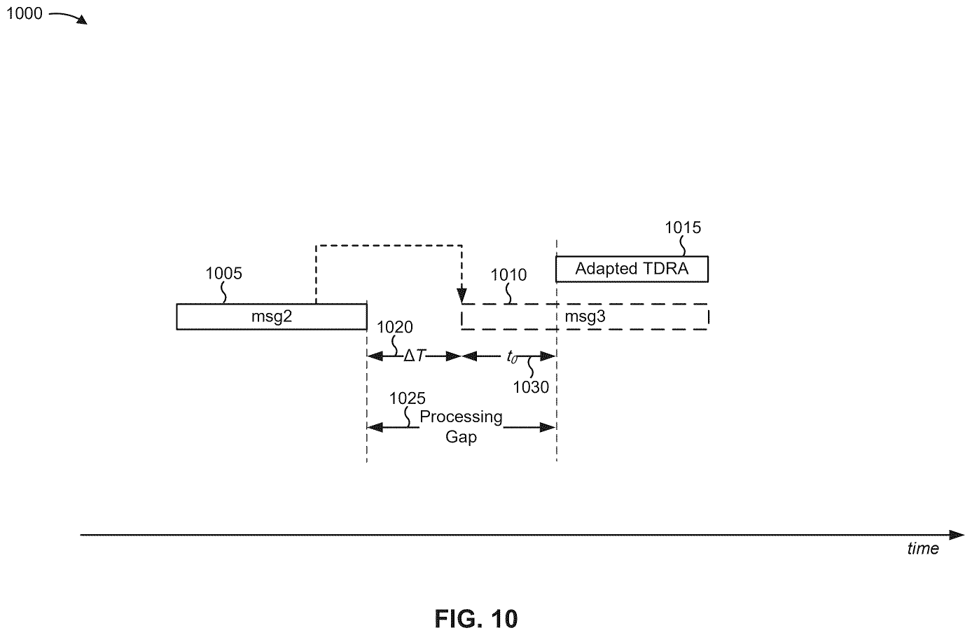

FIG. 10 is a diagram illustrating an example 1000 of an adapted TDRA, in accordance with the present disclosure. As shown in FIG. 10, a low-tier UE (e.g., a low-tier UE as described herein, a UE 120 described in connection with FIGS. 1-7) may perform grant adaptation for a TDRA indicated as part of a RACH procedure. In some aspects, in the absence of an early capability indication in msg1 of a RACH procedure (e.g., that indicates the capabilities of the UE), the low-tier UE may receive, from a network node (e.g., a network node 110 described in connection with FIGS. 1-7, a CU, a DU, and/or an RU), an uplink grant for msg3 of a RACH procedure, such as msg2 1005 of a RACH procedure, including a TDRA 1010 for uplink communications (e.g., for communicating a msg3 of a RACH procedure as described with reference to FIGS. 3, 5, and 7), that indicates a timing offset 1020 between the msg2 1005 and the time resources of the TDRA 1010. In some examples, the timing offset for msg3 transmission may be insufficient for radio frequency and/or baseband processing of the msg2 1005 by the low-tier UE. In some aspects, the FDRA adaptation described with reference to FIGS. 7-9 may incur additional radio frequency and/or baseband processing of the msg2 1005 by the low-tier UE, thus increasing the processing gap 1025.

The network node may transmit signaling that indicates support for (e.g., indicated network node compatibility), enables (e.g., activates and/or indicates an optional action to be taken by the UE), and/or otherwise allows (e.g., removes one or more constraints) the UE to adapt the TDRA 1010 to obtain an adapted TDRA 1015. In some aspects, according to the signaling, in some aspects, the UE may (e.g., may be supported to, may be allowed to, may be indicated to) cancel a quantity of time resources 1030, which may be counted and/or omitted from the beginning of the TDRA 1010, and the UE may transmit the msg3 via the adapted TDRA 1015 without rate-matching. The quantity of time resources 1030 may include enough time resources to extend the timing offset 1020 such that the processing gap 1025 is satisfied. In such aspects, DMRS for the msg3 may not be scheduled within the quantity of time resources 1030 symbols canceled by UE. In some other aspects, according to the signaling, the UE may (e.g., may be supported to, may be allowed to, may be indicated to) cancel a quantity of time resources 1030, which may be counted and/or omitted from the beginning of the TDRA 1010, and the UE may rate-match the msg3 over the time resources of the adapted TDRA 1015. In such aspects, when one or more DMRSs for the msg3 are scheduled to be transmitted during the quantity of time resources 1030, the one or more DMRSs may be deferred and transmitted along with the rate matched uplink communication.

As a result, the low-tier UE may cancel a quantity of UL time resources to accommodate the processing gap 1025, and may transmit the msg3 (e.g., with or without rate-matching) based on the adapted TDRA 1015.

As indicated above, FIG. 10 is provided as an example. Other examples may differ from what is described with respect to FIG. 10.

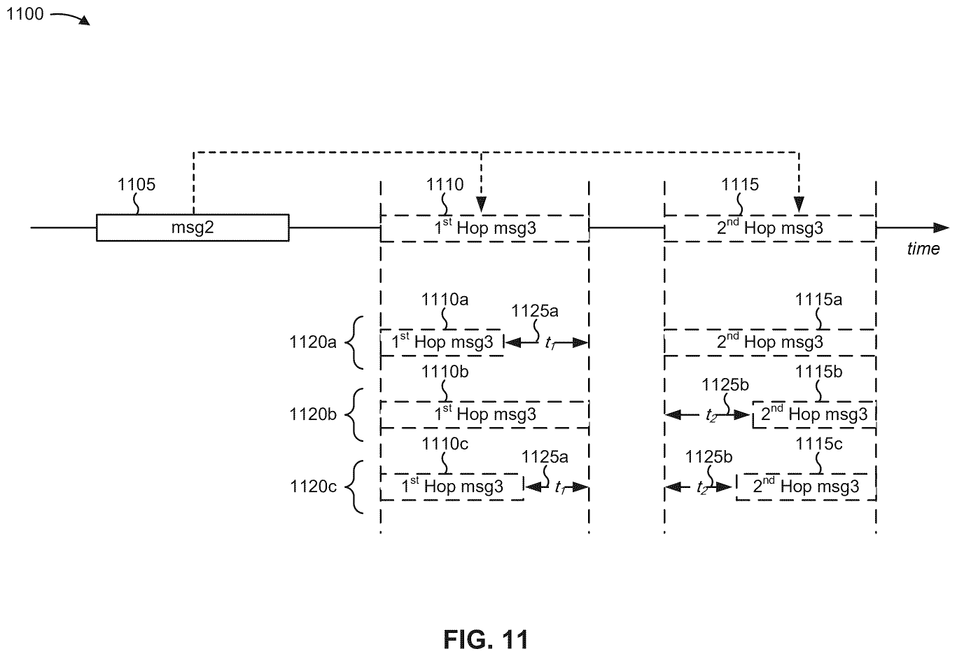

FIG. 11 is a diagram illustrating an example 1100 of an adapted TDRA, in accordance with the present disclosure. As shown in FIG. 11, a low-tier UE (e.g., a low-tier UE as described herein, a UE 120 described in connection with FIGS. 1-7) may perform grant adaptation for a TDRA indicated as part of a RACH procedure. In some aspects, in the absence of an early capability indication in msg1 of a RACH procedure (e.g., that indicates the capabilities of the UE), the low-tier UE may receive, from a network node (e.g., a network node 110 described in connection with FIGS. 1-7, a CU, a DU, and/or an RU), a random access message 1105, such as a msg2 1105, that schedules and/or indicates a TDRA 1120 for a first frequency hop 1110 and a second frequency hop 1115, each associated with time resources for communicating a portion of an uplink RACH message (e.g., a msg3 of a RACH procedure). In some examples, the timing offset between the first hop 1110 and the second hop 1115 may be insufficient for retuning the UE to communicate using a different frequency. In some aspects, the FDRA adaptation described with reference to FIGS. 7-9 may cause scenarios in which retuning is used to perform frequency hopping by the low-tier UE.

The network node may transmit signaling that indicates support for (e.g., indicated network node compatibility), enables (e.g., activates and/or indicates an optional action to be taken by the UE), and/or otherwise allows (e.g., removes one or more constraints) the UE to adapt the TDRA to obtain an adapted TDRA 1120. In some aspects, according to the signaling, in some aspects, the UE may (e.g., may be supported to, may be allowed to, may be indicated to) cancel the last t₁ time resources 1125a of the first hop 1110, and/or the first t₂ time resources 1125b of the second hop 1115.

In a first example, the adapted TDRA 1120a may include the first hop 1110a for which the UE has canceled the last t₁ time resources 1125a of the first hop 1110a to account for the retuning gap and may include the second hop 1115a. In a second example, the adapted TDRA 1120b may include the first hop 1110b and may include the second hop 1115b for which the UE has canceled the first t₂ time resources 1125b of the second hop 1115b to account for the retuning gap. In a third example, the adapted TDRA 1120c may include the first hop 1110c and the second hop 1115c for which the UE has canceled the last t₁ time resources 1125a of the first hop 1110c, and may include the second hop 1115c for which the UE has canceled the first t₂ time resources 1125b of the second hop 1115b to account for the retuning gap.

The UE may transmit the mag3 according to any of the adapted TDRAs 1120 with or without rate-matching the uplink communication.

As indicated above, FIG. 11 is provided as an example. Other examples may differ from what is described with respect to FIG. 11.

FIG. 12 is a diagram illustrating an example process 1200 performed, in some aspects, at a UE or an apparatus of a UE, in accordance with the present disclosure. Example process 1200 is an example where the apparatus or the UE (e.g., UE 120) performs operations associated with random access message based indication of UE capabilities.

As shown in FIG. 12, in some aspects, process 1200 may include receiving, from a network node via a first random access message as part of a random access procedure, an uplink resource grant associated with a first set of capabilities, wherein the UE is associated with a second set of capabilities (block 1210). In some aspects, the UE (e.g., using reception component 1402 and/or communication manager 1406, depicted in FIG. 14) may receive, from a network node via a first random access message as part of a random access procedure, an uplink resource grant associated with a first set of capabilities, wherein the UE is associated with a second set of capabilities, as described above.

As further shown in FIG. 12, in some aspects, process 1200 may include transmitting, via a modified uplink resource grant, a second random access message in accordance with identifying that the uplink resource grant is incompatible with the second set of capabilities (block 1220). In some aspects, the UE (e.g., using transmission component 1404 and/or communication manager 1406, depicted in FIG. 14) may transmit, via a modified uplink resource grant, a second random access message in accordance with identifying that the uplink resource grant is incompatible with the second set of capabilities, as described above.

Process 1200 may include additional aspects, such as any single aspect or any combination of aspects described below and/or in connection with one or more other processes described elsewhere herein.

In a first aspect, process 1200 includes initiating an additional random access procedure in association with identifying that transmitting the second random access message via the modified uplink resource grant failed.

In a second aspect, alone or in combination with the first aspect, process 1200 includes modifying the uplink resource grant to obtain the modified uplink resource grant in association with the second random access message including a msg3 of the random access procedure.

In a third aspect, alone or in combination with one or more of the first and second aspects, process 1200 includes receiving an indication that the network node supports initial access communications with the UE according to the second set of capabilities.

In a fourth aspect, alone or in combination with one or more of the first through third aspects, the second set of capabilities includes a reduced set of capabilities with respect to the first set of capabilities.

In a fifth aspect, alone or in combination with one or more of the first through fourth aspects, the second set of capabilities includes one or more of a reduced bandwidth capability, a reduced latency capability, or a half-duplex communications capability.

In a sixth aspect, alone or in combination with one or more of the first through fifth aspects, the first set of capabilities includes one or more of a bandwidth capability, a latency capability, a full-duplex communication capability.

In a seventh aspect, alone or in combination with one or more of the first through sixth aspects, process 1200 includes receiving signaling indicating a set of time-frequency resources for which the random access procedure is enabled for the UE in association with the UE being associated with the second set of capabilities.

In an eighth aspect, alone or in combination with one or more of the first through seventh aspects, the signaling includes one or more of signal block signaling, information block signaling, radio resource control signaling, or medium access control control element signaling.

In a ninth aspect, alone or in combination with one or more of the first through eighth aspects, the UE is associated with one or more of an idle radio resource control state, or an inactive radio resource control state.

In a tenth aspect, alone or in combination with one or more of the first through ninth aspects, transmitting the second random access message includes transmitting the second random access message including an indication of the second set of capabilities, wherein the modified uplink resource grant at least partially overlaps in at least one of time or frequency with a resource grant for communications at an additional UE that is associated with the first set of capabilities.

In an eleventh aspect, alone or in combination with one or more of the first through tenth aspects, the indication comprises a special access identifier.

In a twelfth aspect, alone or in combination with one or more of the first through eleventh aspects, the indication comprises at least one of an interleaving pattern associated with the second set of capabilities, a scrambling pattern associated with the second set of capabilities, a cyclic redundancy check algorithm associated with the second set of capabilities, or a demodulation reference scheme associated with the second set of capabilities.

In a thirteenth aspect, alone or in combination with one or more of the first through twelfth aspects, process 1200 includes receiving a message including a set of patterns for indicating the second set of capabilities, wherein the message includes system information.

In a fourteenth aspect, alone or in combination with one or more of the first through thirteenth aspects, the uplink resource grant includes a set of patterns for indicating the second set of capabilities.

In a fifteenth aspect, alone or in combination with one or more of the first through fourteenth aspects, the second random access message includes at least one of an initial uplink data channel message, or a retransmitted uplink data channel message.

In a sixteenth aspect, alone or in combination with one or more of the first through fifteenth aspects, transmitting the second random access message is triggered by receiving the first random access message.

In a seventeenth aspect, alone or in combination with one or more of the first through sixteenth aspects, the random access procedure includes a four-step random access procedure and the first random access message includes a msg2, or the random access procedure includes a two-step random access procedure and the first random access message includes a fallback random access response message.

In an eighteenth aspect, alone or in combination with one or more of the first through seventeenth aspects, transmitting the second random access message via the modified uplink resource grant indicates that the UE is associated with the second set of capabilities.

In a nineteenth aspect, alone or in combination with one or more of the first through eighteenth aspects, process 1200 includes receiving an indication that enables the UE to modify the uplink resource grant to include frequency resources indicated by the uplink resource grant that overlap in a frequency domain with a set of frequency resources associated with the UE, and puncturing the second random access message via the modified uplink resource grant that includes a subset of frequency resources indicated by the uplink resource grant, wherein the set of frequency resources associated with the UE includes the subset of frequency resources.

In a twentieth aspect, alone or in combination with one or more of the first through nineteenth aspects, process 1200 includes receiving an indication that enables the UE to modify the uplink resource grant to include frequency resources indicated by the uplink resource grant that overlap with a set of frequency resources associated with the UE, and rate-matching the second random access message via the modified uplink resource grant that includes a subset of frequency resources indicated by the uplink resource grant, wherein the set of frequency resources associated with the UE includes the subset of frequency resources.

In a twenty-first aspect, alone or in combination with one or more of the first through twentieth aspects, process 1200 includes receiving an indication that enables the UE to modify the uplink resource grant to include one or more frequency hops that overlap in a frequency domain with a set of frequency resources indicated by the uplink resource grant, wherein transmitting the second random access message comprises transmitting, via the one or more frequency hops, the second random access message, wherein the set of frequency resources indicated by the uplink resource grant is different from a set of frequency resources associated with the UE.

In a twenty-second aspect, alone or in combination with one or more of the first through twenty-first aspects, process 1200 includes transmitting a third random access message via a first set of frequency resources associated with the UE, wherein transmitting the second random access message comprises transmitting the second random access message via a second set of frequency resources, indicated by the uplink resource grant, in association with switching from communicating via the first set of frequency resources to communicating using the second set of frequency resources, wherein the second set of frequency resources is a subset of the first set of frequency resources.

In a twenty-third aspect, alone or in combination with one or more of the first through twenty-second aspects, the modified uplink resource grant includes the second set of frequency resources in association with the UE being associated with the second set of capabilities.

In a twenty-fourth aspect, alone or in combination with one or more of the first through twenty-third aspects, a set of frequency resources indicated by the uplink resource grant is larger than a set of frequency resources associated with the UE, the method further comprising refraining from transmitting the second random access message via the set of frequency resources indicated by the uplink resource grant.

In a twenty-fifth aspect, alone or in combination with one or more of the first through twenty-fourth aspects, process 1200 includes receiving an indication that enables the UE to modify the uplink resource grant to omit one or more time resources, including a first-occurring time resource, indicated by the uplink resource grant to obtain a subset of time resources, wherein a time offset between the first random access message and the first-occurring time resource is less than a time offset for the UE to switch from communicating via a first frequency range to a second frequency range.

In a twenty-sixth aspect, alone or in combination with one or more of the first through twenty-fifth aspects, one or more reference signals are scheduled for transmission via at least one time resource subsequent to the first-occurring time resource in association with omitting the one or more time resources.

In a twenty-seventh aspect, alone or in combination with one or more of the first through twenty-sixth aspects, process 1200 includes rate-matching the second random access message via the modified uplink resource grant that includes the subset of time resources in association with omitting the one or more time resources.

In a twenty-eighth aspect, alone or in combination with one or more of the first through twenty-seventh aspects, process 1200 includes receiving an indication that enables the UE to modify the uplink resource grant to omit one or more time resources associated with at least one of a first frequency hop or a second frequency hop, wherein a time offset between the first frequency hop and the second frequency hops is less than a retuning gap associated with the UE, wherein transmitting the second random access message comprises transmitting the second random access message via the modified uplink resource grant including one or more of a set of time resources associated with the first frequency hop, a set of time resources associated with the second frequency hop, a subset of time resources associated with the first frequency hop, or a subset of resources associated with the second frequency hop.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, in some aspects, at a network node or an apparatus of a network node, in accordance with the present disclosure. Example process 1300 is an example where the apparatus or the network node (e.g., network node 110) performs operations associated with random access message based indication of UE capabilities.

As shown in FIG. 13, in some aspects, process 1300 may include transmitting, to a UE via a first random access message as part of a random access procedure, an uplink resource grant associated with a first set of UE capabilities, wherein the UE is associated with a second set of UE capabilities (block 1310). In some aspects, the network node (e.g., using transmission component 1504 and/or communication manager 1506, depicted in FIG. 15) may transmit, to a UE via a first random access message as part of a random access procedure, an uplink resource grant associated with a first set of UE capabilities, wherein the UE is associated with a second set of UE capabilities, as described above.

As further shown in FIG. 13, in some aspects, process 1300 may include receiving, via a modified uplink resource grant in accordance with the UE being associated with the second set of UE capabilities, a second random access message (block 1320). In some aspects, the network node (e.g., using reception component 1502 and/or communication manager 1506, depicted in FIG. 15) may receive, via a modified uplink resource grant in accordance with the UE being associated with the second set of UE capabilities, a second random access message, as described above.

Process 1300 may include additional aspects, such as any single aspect or any combination of aspects described below and/or in connection with one or more other processes described elsewhere herein.

In a first aspect, process 1300 includes transmitting an indication that the network node supports initial access communications with the UE according to the second set of capabilities.

In a second aspect, alone or in combination with the first aspect, the second set of capabilities includes a reduced set of capabilities with respect to the first set of capabilities.

In a third aspect, alone or in combination with one or more of the first and second aspects, the second set of capabilities includes one or more of a reduced bandwidth capability, a reduced latency capability, or a half-duplex communications capability.

In a fourth aspect, alone or in combination with one or more of the first through third aspects, the first set of capabilities includes one or more of a bandwidth capability, a latency capability, a full-duplex communication capability.

In a fifth aspect, alone or in combination with one or more of the first through fourth aspects, process 1300 includes transmitting signaling indicating a set of time-frequency resources for which the random access procedure is enabled for the UE in association with the UE being associated with the second set of capabilities.

In a sixth aspect, alone or in combination with one or more of the first through fifth aspects, the signaling includes one or more of signal block signaling, information block signaling, radio resource control signaling, or medium access control control element signaling.

In a seventh aspect, alone or in combination with one or more of the first through sixth aspects, the UE is associated with one or more of an idle radio resource control state, or an inactive radio resource control state.

In an eighth aspect, alone or in combination with one or more of the first through seventh aspects, receiving the second random access message includes receiving the second random access message including an indication of the second set of capabilities, wherein the modified uplink resource grant at least partially overlaps in at least one of time or frequency with a resource grant for communications at an additional UE that is associated with the first set of capabilities.

In a ninth aspect, alone or in combination with one or more of the first through eighth aspects, the indication comprises a special access identifier.

In a tenth aspect, alone or in combination with one or more of the first through ninth aspects, the indication comprises at least one of an interleaving pattern associated with the second set of capabilities, a scrambling pattern associated with the second set of capabilities, a cyclic redundancy check algorithm associated with the second set of capabilities, or a demodulation reference scheme associated with the second set of capabilities.

In an eleventh aspect, alone or in combination with one or more of the first through tenth aspects, process 1300 includes transmitting a message including a set of patterns for indicating the second set of capabilities, wherein the message includes system information.

In a twelfth aspect, alone or in combination with one or more of the first through eleventh aspects, the uplink resource grant includes a set of patterns for indicating the second set of capabilities.

In a thirteenth aspect, alone or in combination with one or more of the first through twelfth aspects, the second random access message includes at least one of an initial uplink data channel message, or a retransmitted uplink data channel message.

In a fourteenth aspect, alone or in combination with one or more of the first through thirteenth aspects, the random access procedure includes a four-step random access procedure and the first random access message includes a msg2, or the random access procedure includes a two-step random access procedure and the first random access message includes a fallback random access response message.

In a fifteenth aspect, alone or in combination with one or more of the first through fourteenth aspects, receiving the second random access message via the modified uplink resource grant indicates that the UE is associated with the second set of capabilities.

In a sixteenth aspect, alone or in combination with one or more of the first through fifteenth aspects, process 1300 includes transmitting an indication that enables the UE to modify the uplink resource grant to include frequency resources indicated by the uplink resource grant that overlap in a frequency domain with a set of frequency resources associated with the UE.

In a seventeenth aspect, alone or in combination with one or more of the first through sixteenth aspects, process 1300 includes transmitting an indication that enables the UE to modify the uplink resource grant to include frequency resources indicated by the uplink resource grant that overlap with a set of frequency resources associated with the UE.

In an eighteenth aspect, alone or in combination with one or more of the first through seventeenth aspects, process 1300 includes transmitting an indication that enables the UE to modify the uplink resource grant to include one or more frequency hops that overlap in a frequency domain with a set of frequency resources indicated by the uplink resource grant.

In a nineteenth aspect, alone or in combination with one or more of the first through eighteenth aspects, process 1300 includes receiving a third random access message via a first set of frequency resources associated with the UE, wherein receiving the second random access message comprises receiving the second random access message via a second set of frequency resources, indicated by the uplink resource grant, in association with the UE switching from communicating via the first set of frequency resources to communicating using the second set of frequency resources, wherein the second set of frequency resources is a subset of the first set of frequency resources.

In a twentieth aspect, alone or in combination with one or more of the first through nineteenth aspects, the modified uplink resource grant includes the second set of frequency resources in association with the UE being associated with the second set of capabilities.

In a twenty-first aspect, alone or in combination with one or more of the first through twentieth aspects, process 1300 includes refraining from including a set of frequency resources in the uplink resource grant that is larger than a set of frequency resources associated with the UE.

In a twenty-second aspect, alone or in combination with one or more of the first through twenty-first aspects, process 1300 includes transmitting, to an additional UE via a third random access message, an additional uplink resource grant including a set of frequency resources that is multiplexed with the set of frequency resources in the uplink resource grant, and that is smaller than a set of frequency resources associated with at least one of the UE or the additional UE.

In a twenty-third aspect, alone or in combination with one or more of the first through twenty-second aspects, process 1300 includes transmitting an indication that enables the UE to modify the uplink resource grant to omit one or more time resources, including a first-occurring time resource, indicated by the uplink resource grant to obtain a subset of time resources, wherein a time offset between the first random access message and the first-occurring time resource is less than a time offset for the UE to switch from communicating via a first frequency range to a second frequency range.

In a twenty-fourth aspect, alone or in combination with one or more of the first through twenty-third aspects, one or more reference signals are scheduled for communication via at least one time resource subsequent to the first-occurring time resource in association with enabling the UE to modify the uplink resource grant to omit one or more time resources.

In a twenty-fifth aspect, alone or in combination with one or more of the first through twenty-fourth aspects, receiving the second random access message comprises receiving the second random access message that is rate-matched via the modified uplink resource grant including the subset of time resources in association with enabling the UE to modify the uplink resource grant to omit one or more time resources.

In a twenty-sixth aspect, alone or in combination with one or more of the first through twenty-fifth aspects, process 1300 includes transmitting an indication that enables the UE to modify the uplink resource grant to omit one or more time resources associated with at least one of a first frequency hop or a second frequency hop, wherein a time offset between the first frequency hop and the second frequency hops is less than a retuning gap associated with the UE, wherein receiving the second random access message comprises receiving the second random access message via the modified uplink resource grant including one or more of a set of time resources associated with the first frequency hop, a set of time resources associated with the second frequency hop, a subset of time resources associated with the first frequency hop, or a subset of resources associated with the second frequency hop.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a diagram of an example apparatus 1400 for wireless communication, in accordance with the present disclosure. The apparatus 1400 may be a UE, or a UE may include the apparatus 1400. In some aspects, the apparatus 1400 includes a reception component 1402, a transmission component 1404, and/or a communication manager 1406, which may be in communication with one another (in some aspects, via one or more buses and/or one or more other components). In some aspects, the communication manager 1406 is the communication manager 150 described in connection with FIG. 1. As shown, the apparatus 1400 may communicate with another apparatus 1408, such as a UE or a network node (such as a CU, a DU, an RU, or a base station), using the reception component 1402 and the transmission component 1404. The communication manager 1406 may be included in, or implemented via, a processing system (in some aspects, the processing system 140 described in connection with FIG. 1) of the UE.

In some aspects, the apparatus 1400 may be configured to perform one or more operations described herein in connection with FIGS. 7-11. Additionally, or alternatively, the apparatus 1400 may be configured to perform one or more processes described herein, such as process 1200 of FIG. 12, or a combination thereof. In some aspects, the apparatus 1400 and/or one or more components shown in FIG. 14 may include one or more components of the UE described in connection with FIG. 1. Additionally, or alternatively, one or more components shown in FIG. 14 may be implemented within one or more components described in connection with FIG. 1. Additionally, or alternatively, one or more components of the set of components may be implemented at least in part as software stored in one or more memories. In some aspects, a component (or a portion of a component) may be implemented as instructions or code stored in a non-transitory computer-readable medium and executable by one or more controllers or one or more processors to perform the functions or operations of the component.

The reception component 1402 may receive communications, such as reference signals, control information, data communications, or a combination thereof, from the apparatus 1408. The reception component 1402 may provide received communications to one or more other components of the apparatus 1400. In some aspects, the reception component 1402 may perform signal processing on the received communications and may provide the processed signals to the one or more other components of the apparatus 1400. In some aspects, the reception component 1402 may include one or more components of the UE described above in connection with FIG. 1, such as a radio, one or more RF chains, one or more transceivers, or one or more modems, each of which may in turn be coupled with one or more antennas of the UE.

The transmission component 1404 may transmit communications, such as reference signals, control information, data communications, or a combination thereof, to the apparatus 1408. In some aspects, one or more other components of the apparatus 1400 may generate communications and may provide the generated communications to the transmission component 1404 for transmission to the apparatus 1408. In some aspects, the transmission component 1404 may perform signal processing on the generated communications and may transmit the processed signals to the apparatus 1408. In some aspects, the transmission component 1404 may include one or more components of the UE described above in connection with FIG. 1, such as a radio, one or more RF chains, one or more transceivers, or one or more modems, each of which may in turn be coupled with one or more antennas of the UE described in connection with FIG. 1. In some aspects, the transmission component 1404 may be co-located with the reception component 1402.

The communication manager 1406 may support operations of the reception component 1402 and/or the transmission component 1404. In some aspects, the communication manager 1406 may receive information associated with configuring reception of communications by the reception component 1402 and/or transmission of communications by the transmission component 1404. Additionally, or alternatively, the communication manager 1406 may generate and/or provide control information to the reception component 1402 and/or the transmission component 1404 to control reception and/or transmission of communications.

The reception component 1402 may receive, from a network node via a first random access message as part of a random access procedure, an uplink resource grant associated with a first set of capabilities, wherein the UE is associated with a second set of capabilities. The transmission component 1404 may transmit, via a modified uplink resource grant, a second random access message in accordance with identifying that the uplink resource grant is incompatible with the second set of capabilities.

The communication manager 1406 may initiate an additional random access procedure in association with identifying that transmitting the second random access message via the modified uplink resource grant failed.

The communication manager 1406 may modify the uplink resource grant to obtain the modified uplink resource grant in association with the second random access message including a msg3 of the random access procedure.

The reception component 1402 may receive an indication that the network node supports initial access communications with the UE according to the second set of capabilities.

The reception component 1402 may receive signaling indicating a set of time-frequency resources for which the random access procedure is enabled for the UE in association with the UE being associated with the second set of capabilities.

The reception component 1402 may receive a message including a set of patterns for indicating the second set of capabilities, wherein the message includes system information.

The reception component 1402 may receive an indication that enables the UE to modify the uplink resource grant to include frequency resources indicated by the uplink resource grant that overlap in a frequency domain with a set of frequency resources associated with the UE.

The communication manager 1406 may puncture the second random access message via the modified uplink resource grant that includes a subset of frequency resources indicated by the uplink resource grant, wherein the set of frequency resources associated with the UE includes the subset of frequency resources.

The reception component 1402 may receive an indication that enables the UE to modify the uplink resource grant to include one or more frequency hops that overlap in a frequency domain with a set of frequency resources indicated by the uplink resource grant, wherein transmitting the second random access message comprises.

The transmission component 1404 may transmit, via the one or more frequency hops, the second random access message, wherein the set of frequency resources indicated by the uplink resource grant is different from a set of frequency resources associated with the UE.

The transmission component 1404 may transmit a third random access message via a first set of frequency resources associated with the UE, wherein transmitting the second random access message comprises.

The transmission component 1404 may transmit the second random access message via a second set of frequency resources, indicated by the uplink resource grant, in association with switching from communicating via the first set of frequency resources to communicating using the second set of frequency resources, wherein the second set of frequency resources is a subset of the first set of frequency resources.

The reception component 1402 may receive an indication that enables the UE to modify the uplink resource grant to omit one or more time resources, including a first-occurring time resource, indicated by the uplink resource grant to obtain a subset of time resources, wherein a time offset between the first random access message and the first-occurring time resource is less than a time offset for the UE to switch from communicating via a first frequency range to a second frequency range.

The reception component 1402 may receive an indication that enables the UE to modify the uplink resource grant to omit one or more time resources associated with at least one of a first frequency hop or a second frequency hop, wherein a time offset between the first frequency hop and the second frequency hops is less than a retuning gap associated with the UE, wherein transmitting the second random access message comprises.

The transmission component 1404 may transmit the second random access message via the modified uplink resource grant including one or more of a set of time resources associated with the first frequency hop, a set of time resources associated with the second frequency hop, a subset of time resources associated with the first frequency hop, or a subset of resources associated with the second frequency hop.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a diagram of an example apparatus 1500 for wireless communication, in accordance with the present disclosure. The apparatus 1500 may be a network node, or a network node may include the apparatus 1500. In some aspects, the apparatus 1500 includes a reception component 1502, a transmission component 1504, and/or a communication manager 1506, which may be in communication with one another (in some aspects, via one or more buses and/or one or more other components). In some aspects, the communication manager 1506 is the communication manager 155 described in connection with FIG. 1. As shown, the apparatus 1500 may communicate with another apparatus 1508, such as a UE or a network node (such as a CU, a DU, an RU, or a base station), using the reception component 1502 and the transmission component 1504. The communication manager 1506 may be included in, or implemented via, a processing system (in some aspects, the processing system 145 described in connection with FIG. 1) of the network node.

In some aspects, the apparatus 1500 may be configured to perform one or more operations described herein in connection with FIGS. 7-11. Additionally, or alternatively, the apparatus 1500 may be configured to perform one or more processes described herein, such as process 1300 of FIG. 13, or a combination thereof. In some aspects, the apparatus 1500 and/or one or more components shown in FIG. 15 may include one or more components of the network node described in connection with FIG. 1. Additionally, or alternatively, one or more components shown in FIG. 15 may be implemented within one or more components described in connection with FIG. 1. Additionally, or alternatively, one or more components of the set of components may be implemented at least in part as software stored in one or more memories. In some aspects, a component (or a portion of a component) may be implemented as instructions or code stored in a non-transitory computer-readable medium and executable by one or more controllers or one or more processors to perform the functions or operations of the component.

The reception component 1502 may receive communications, such as reference signals, control information, data communications, or a combination thereof, from the apparatus 1508. The reception component 1502 may provide received communications to one or more other components of the apparatus 1500. In some aspects, the reception component 1502 may perform signal processing on the received communications, and may provide the processed signals to the one or more other components of the apparatus 1500. In some aspects, the reception component 1502 may include one or more components of the network node described above in connection with FIG. 1, such as a radio, one or more RF chains, one or more transceivers, or one or more modems, each of which may in turn be coupled with one or more antennas of the network node. In some aspects, the reception component 1502 and/or the transmission component 1504 may include or may be included in a network interface. The network interface may be configured to obtain and/or output signals for the apparatus 1500 via one or more communications links, such as a backhaul link, a midhaul link, and/or a fronthaul link.

The transmission component 1504 may transmit communications, such as reference signals, control information, data communications, or a combination thereof, to the apparatus 1508. In some aspects, one or more other components of the apparatus 1500 may generate communications and may provide the generated communications to the transmission component 1504 for transmission to the apparatus 1508. In some aspects, the transmission component 1504 may perform signal processing on the generated communications, and may transmit the processed signals to the apparatus 1508. In some aspects, the transmission component 1504 may include one or more components of the network node described above in connection with FIG. 1, such as a radio, one or more RF chains, one or more transceivers, or one or more modems, each of which may in turn be coupled with one or more antennas of the network node described in connection with FIG. 1. In some aspects, the transmission component 1504 may be co-located with the reception component 1502.

The communication manager 1506 may support operations of the reception component 1502 and/or the transmission component 1504. In some aspects, the communication manager 1506 may receive information associated with configuring reception of communications by the reception component 1502 and/or transmission of communications by the transmission component 1504. Additionally, or alternatively, the communication manager 1506 may generate and/or provide control information to the reception component 1502 and/or the transmission component 1504 to control reception and/or transmission of communications.

The transmission component 1504 may transmit, to a UE via a first random access message as part of a random access procedure, an uplink resource grant associated with a first set of UE capabilities, wherein the UE is associated with a second set of UE capabilities. The reception component 1502 may receive, via a modified uplink resource grant in accordance with the UE being associated with the second set of UE capabilities, a second random access message.

The transmission component 1504 may transmit an indication that the network node supports initial access communications with the UE according to the second set of capabilities.

The transmission component 1504 may transmit signaling indicating a set of time-frequency resources for which the random access procedure is enabled for the UE in association with the UE being associated with the second set of capabilities.

The transmission component 1504 may transmit a message including a set of patterns for indicating the second set of capabilities, wherein the message includes system information.

The transmission component 1504 may transmit an indication that enables the UE to modify the uplink resource grant to include frequency resources indicated by the uplink resource grant that overlap in a frequency domain with a set of frequency resources associated with the UE.

The transmission component 1504 may transmit an indication that enables the UE to modify the uplink resource grant to include frequency resources indicated by the uplink resource grant that overlap with a set of frequency resources associated with the UE.

The transmission component 1504 may transmit an indication that enables the UE to modify the uplink resource grant to include one or more frequency hops that overlap in a frequency domain with a set of frequency resources indicated by the uplink resource grant.

The reception component 1502 may receive a third random access message via a first set of frequency resources associated with the UE, wherein receiving the second random access message comprises.

The reception component 1502 may receive the second random access message via a second set of frequency resources, indicated by the uplink resource grant, in association with the UE switching from communicating via the first set of frequency resources to communicating using the second set of frequency resources, wherein the second set of frequency resources is a subset of the first set of frequency resources.

The communication manager 1506 may refrain from including a set of frequency resources in the uplink resource grant that is larger than a set of frequency resources associated with the UE.

The transmission component 1504 may transmit, to an additional UE via a third random access message, an additional uplink resource grant including a set of frequency resources that is multiplexed with the set of frequency resources in the uplink resource grant, and that is smaller than a set of frequency resources associated with at least one of the UE or the additional UE.

The transmission component 1504 may transmit an indication that enables the UE to modify the uplink resource grant to omit one or more time resources, including a first-occurring time resource, indicated by the uplink resource grant to obtain a subset of time resources, wherein a time offset between the first random access message and the first-occurring time resource is less than a time offset for the UE to switch from communicating via a first frequency range to a second frequency range.

The transmission component 1504 may transmit an indication that enables the UE to modify the uplink resource grant to omit one or more time resources associated with at least one of a first frequency hop or a second frequency hop, wherein a time offset between the first frequency hop and the second frequency hops is less than a retuning gap associated with the UE, wherein receiving the second random access message comprises.

The reception component 1502 may receive the second random access message via the modified uplink resource grant including one or more of a set of time resources associated with the first frequency hop, a set of time resources associated with the second frequency hop, a subset of time resources associated with the first frequency hop, or a subset of resources associated with the second frequency hop.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

The following provides an overview of some Aspects of the present disclosure:

Aspect 1: A method of wireless communication performed by a user equipment (UE), comprising: receiving, from a network node via a first random access message as part of a random access procedure, an uplink resource grant associated with a first set of capabilities, wherein the UE is associated with a second set of capabilities; and transmitting, via a modified uplink resource grant, a second random access message in accordance with identifying that the uplink resource grant is incompatible with the second set of capabilities.

Aspect 2: The method of Aspect 1, further comprising: initiating an additional random access procedure in association with identifying that transmitting the second random access message via the modified uplink resource grant failed.

Aspect 3: The method of any of Aspects 1-2, further comprising: modifying the uplink resource grant to obtain the modified uplink resource grant in association with the second random access message including a msg3 of the random access procedure.

Aspect 4: The method of any of Aspects 1-3, further comprising: receiving an indication that the network node supports initial access communications with the UE according to the second set of capabilities.

Aspect 5: The method of any of Aspects 1-4, wherein the second set of capabilities includes a reduced set of capabilities with respect to the first set of capabilities.

Aspect 6: The method of any of Aspects 1-5, wherein the second set of capabilities includes one or more of: a reduced bandwidth capability, a reduced latency capability, or a half-duplex communications capability.

Aspect 7: The method of any of Aspects 1-6, wherein the first set of capabilities includes one or more of: a bandwidth capability, a latency capability, a full-duplex communication capability.

Aspect 8: The method of any of Aspects 1-7, further comprising: receiving signaling indicating a set of time-frequency resources for which the random access procedure is enabled for the UE in association with the UE being associated with the second set of capabilities.

Aspect 9: The method of Aspect 8, wherein the signaling includes one or more of: synchronization signal block signaling, system information block signaling, radio resource control signaling, or medium access control control element signaling.

Aspect 10: The method of any of Aspects 1-9, wherein the UE is associated with one or more of: an idle radio resource control state, or an inactive radio resource control state.

Aspect 11: The method of any of Aspects 1-10, wherein transmitting the second random access message includes: transmitting the second random access message including an indication of the second set of capabilities, wherein the modified uplink resource grant at least partially overlaps in at least one of time or frequency with a resource grant for communications at an additional UE that is associated with the first set of capabilities.

Aspect 12: The method of Aspect 11, wherein the indication comprises a special access identifier.

Aspect 13: The method of any of Aspects 11-12, wherein the indication comprises at least one of: an interleaving pattern associated with the second set of capabilities, a scrambling pattern associated with the second set of capabilities, a cyclic redundancy check algorithm associated with the second set of capabilities, or a demodulation reference scheme associated with the second set of capabilities.

Aspect 14: The method of any of Aspects 11-13, further comprising: receiving a message including a set of patterns for indicating the second set of capabilities, wherein the message includes system information.

Aspect 15: The method of any of Aspects 11-14, wherein the uplink resource grant includes a set of patterns for indicating the second set of capabilities.

Aspect 16: The method of any of Aspects 1-15, wherein the second random access message includes at least one of: an initial uplink data channel message, or a retransmitted uplink data channel message.

Aspect 17: The method of any of Aspects 1-16, wherein transmitting the second random access message is triggered by receiving the first random access message.

Aspect 18: The method of any of Aspects 1-17, wherein: the random access procedure includes a four-step random access procedure and the first random access message includes a msg2, or the random access procedure includes a two-step random access procedure and the first random access message includes a fallback random access response message.

Aspect 19: The method of any of Aspects 1-18, wherein transmitting the second random access message via the modified uplink resource grant indicates that the UE is associated with the second set of capabilities.

Aspect 20: The method of any of Aspects 1-19, further comprising: receiving an indication that enables the UE to modify the uplink resource grant to include frequency resources indicated by the uplink resource grant that overlap in a frequency domain with a set of frequency resources associated with the UE; and puncturing the second random access message via the modified uplink resource grant that includes a subset of frequency resources indicated by the uplink resource grant, wherein the set of frequency resources associated with the UE includes the subset of frequency resources.

Aspect 21: The method of any of Aspects 1-20, further comprising: receiving an indication that enables the UE to modify the uplink resource grant to include frequency resources indicated by the uplink resource grant that overlap with a set of frequency resources associated with the UE; and rate-matching the second random access message via the modified uplink resource grant that includes a subset of frequency resources indicated by the uplink resource grant, wherein the set of frequency resources associated with the UE includes the subset of frequency resources.

Aspect 22: The method of any of Aspects 1-21, further comprising: receiving an indication that enables the UE to modify the uplink resource grant to include one or more frequency hops that overlap in a frequency domain with a set of frequency resources indicated by the uplink resource grant, wherein transmitting the second random access message comprises: transmitting, via the one or more frequency hops, the second random access message, wherein the set of frequency resources indicated by the uplink resource grant is different from a set of frequency resources associated with the UE.

Aspect 23: The method of any of Aspects 1-22, further comprising: transmitting a third random access message via a first set of frequency resources associated with the UE, wherein transmitting the second random access message comprises: transmitting the second random access message via a second set of frequency resources, indicated by the uplink resource grant, in association with switching from communicating via the first set of frequency resources to communicating using the second set of frequency resources, wherein the second set of frequency resources is a subset of the first set of frequency resources.

Aspect 24: The method of Aspect 23, wherein the modified uplink resource grant includes the second set of frequency resources in association with the UE being associated with the second set of capabilities.

Aspect 25: The method of any of Aspects 1-24, wherein a set of frequency resources indicated by the uplink resource grant is larger than a set of frequency resources associated with the UE, the method further comprising: refraining from transmitting the second random access message via the set of frequency resources indicated by the uplink resource grant.

Aspect 26: The method of any of Aspects 1-25, further comprising: receiving an indication that enables the UE to modify the uplink resource grant to omit one or more time resources, including a first-occurring time resource, indicated by the uplink resource grant to obtain a subset of time resources, wherein a time offset between the first random access message and the first-occurring time resource is less than a time offset for the UE to switch from communicating via a first frequency range to a second frequency range.

Aspect 27: The method of Aspect 26, wherein one or more reference signals are scheduled for transmission via at least one time resource subsequent to the first-occurring time resource in association with omitting the one or more time resources.

Aspect 28: The method of any of Aspects 26-27, further comprising: rate-matching the second random access message via the modified uplink resource grant that includes the subset of time resources in association with omitting the one or more time resources.

Aspect 29: The method of any of Aspects 1-28, further comprising: receiving an indication that enables the UE to modify the uplink resource grant to omit one or more time resources associated with at least one of a first frequency hop or a second frequency hop, wherein a time offset between the first frequency hop and the second frequency hops is less than a retuning gap associated with the UE, wherein transmitting the second random access message comprises: transmitting the second random access message via the modified uplink resource grant including one or more of a set of time resources associated with the first frequency hop, a set of time resources associated with the second frequency hop, a subset of time resources associated with the first frequency hop, or a subset of resources associated with the second frequency hop.

Aspect 30: A method of wireless communication performed by a network node, comprising: transmitting, to a user equipment (UE) via a first random access message as part of a random access procedure, an uplink resource grant associated with a first set of UE capabilities, wherein the UE is associated with a second set of UE capabilities; and receiving, via a modified uplink resource grant in accordance with the UE being associated with the second set of UE capabilities, a second random access message.

Aspect 31: The method of Aspect 30, further comprising: transmitting an indication that the network node supports initial access communications with the UE according to the second set of capabilities.

Aspect 32: The method of any of Aspects 30-31, wherein the second set of capabilities includes a reduced set of capabilities with respect to the first set of capabilities.

Aspect 33: The method of any of Aspects 30-32, wherein the second set of capabilities includes one or more of: a reduced bandwidth capability, a reduced latency capability, or a half-duplex communications capability.

Aspect 34: The method of any of Aspects 30-33, wherein the first set of capabilities includes one or more of: a bandwidth capability, a latency capability, a full-duplex communication capability.

Aspect 35: The method of any of Aspects 30-34, further comprising: transmitting signaling indicating a set of time-frequency resources for which the random access procedure is enabled for the UE in association with the UE being associated with the second set of capabilities.

Aspect 36: The method of Aspect 35, wherein the signaling includes one or more of: synchronization signal block signaling, system information block signaling, radio resource control signaling, or medium access control control element signaling.

Aspect 37: The method of any of Aspects 30-36, wherein the UE is associated with one or more of: an idle radio resource control state, or an inactive radio resource control state.

Aspect 38: The method of any of Aspects 30-37, wherein receiving the second random access message includes: receiving the second random access message including an indication of the second set of capabilities, wherein the modified uplink resource grant at least partially overlaps in at least one of time or frequency with a resource grant for communications at an additional UE that is associated with the first set of capabilities.

Aspect 39: The method of Aspect 38, wherein the indication comprises a special access identifier.

Aspect 40: The method of any of Aspects 38-39, wherein the indication comprises at least one of: an interleaving pattern associated with the second set of capabilities, a scrambling pattern associated with the second set of capabilities, a cyclic redundancy check algorithm associated with the second set of capabilities, or a demodulation reference scheme associated with the second set of capabilities.

Aspect 41: The method of any of Aspects 38-40, further comprising: transmitting a message including a set of patterns for indicating the second set of capabilities, wherein the message includes system information.

Aspect 42: The method of any of Aspects 38-41, wherein the uplink resource grant includes a set of patterns for indicating the second set of capabilities.

Aspect 43: The method of any of Aspects 30-42, wherein the second random access message includes at least one of: an initial uplink data channel message, or a retransmitted uplink data channel message.

Aspect 44: The method of any of Aspects 30-43, wherein: the random access procedure includes a four-step random access procedure and the first random access message includes a msg2, or the random access procedure includes a two-step random access procedure and the first random access message includes a fallback random access response message.

Aspect 45: The method of any of Aspects 30-44, wherein receiving the second random access message via the modified uplink resource grant indicates that the UE is associated with the second set of capabilities.

Aspect 46: The method of any of Aspects 30-45, further comprising: transmitting an indication that enables the UE to modify the uplink resource grant to include frequency resources indicated by the uplink resource grant that overlap in a frequency domain with a set of frequency resources associated with the UE.

Aspect 47: The method of any of Aspects 30-46, further comprising: transmitting an indication that enables the UE to modify the uplink resource grant to include frequency resources indicated by the uplink resource grant that overlap with a set of frequency resources associated with the UE.

Aspect 48: The method of any of Aspects 30-47, further comprising: transmitting an indication that enables the UE to modify the uplink resource grant to include one or more frequency hops that overlap in a frequency domain with a set of frequency resources indicated by the uplink resource grant.

Aspect 49: The method of any of Aspects 30-48, further comprising: receiving a third random access message via a first set of frequency resources associated with the UE, wherein receiving the second random access message comprises: receiving the second random access message via a second set of frequency resources, indicated by the uplink resource grant, in association with the UE switching from communicating via the first set of frequency resources to communicating using the second set of frequency resources, wherein the second set of frequency resources is a subset of the first set of frequency resources.

Aspect 50: The method of Aspect 49, wherein the modified uplink resource grant includes the second set of frequency resources in association with the UE being associated with the second set of capabilities.

Aspect 51: The method of any of Aspects 30-50, further comprising: refraining from including a set of frequency resources in the uplink resource grant that is larger than a set of frequency resources associated with the UE.

Aspect 52: The method of Aspect 51, further comprising: transmitting, to an additional UE via a third random access message, an additional uplink resource grant including a set of frequency resources that is multiplexed with the set of frequency resources in the uplink resource grant, and that is smaller than a set of frequency resources associated with at least one of the UE or the additional UE.

Aspect 53: The method of any of Aspects 30-52, further comprising: transmitting an indication that enables the UE to modify the uplink resource grant to omit one or more time resources, including a first-occurring time resource, indicated by the uplink resource grant to obtain a subset of time resources, wherein a time offset between the first random access message and the first-occurring time resource is less than a time offset for the UE to switch from communicating via a first frequency range to a second frequency range.

Aspect 54: The method of Aspect 53, wherein one or more reference signals are scheduled for communication via at least one time resource subsequent to the first-occurring time resource in association with enabling the UE to modify the uplink resource grant to omit one or more time resources.

Aspect 55: The method of any of Aspects 53-54, wherein receiving the second random access message comprises: receiving the second random access message that is rate-matched via the modified uplink resource grant including the subset of time resources in association with enabling the UE to modify the uplink resource grant to omit one or more time resources.

Aspect 56: The method of any of Aspects 30-55, further comprising: transmitting an indication that enables the UE to modify the uplink resource grant to omit one or more time resources associated with at least one of a first frequency hop or a second frequency hop, wherein a time offset between the first frequency hop and the second frequency hops is less than a retuning gap associated with the UE, wherein receiving the second random access message comprises: receiving the second random access message via the modified uplink resource grant including one or more of a set of time resources associated with the first frequency hop, a set of time resources associated with the second frequency hop, a subset of time resources associated with the first frequency hop, or a subset of resources associated with the second frequency hop.

Aspect 57: An apparatus for wireless communication at a device, the apparatus comprising one or more processors; one or more memories coupled with the one or more processors; and instructions stored in the one or more memories and executable by the one or more processors to cause the apparatus to perform the method of one or more of Aspects 1-56.

Aspect 58: An apparatus for wireless communication at a device, the apparatus comprising one or more memories and one or more processors coupled to the one or more memories, the one or more processors configured to cause the device to perform the method of one or more of Aspects 1-56.

Aspect 59: An apparatus for wireless communication, the apparatus comprising at least one means for performing the method of one or more of Aspects 1-56.

Aspect 60: A non-transitory computer-readable medium storing code for wireless communication, the code comprising instructions executable by one or more processors to perform the method of one or more of Aspects 1-56.

Aspect 61: A non-transitory computer-readable medium storing a set of instructions for wireless communication, the set of instructions comprising one or more instructions that, when executed by one or more processors of a device, cause the device to perform the method of one or more of Aspects 1-56.

Aspect 62: A device for wireless communication, the device comprising a processing system that includes one or more processors and one or more memories coupled with the one or more processors, the processing system configured to cause the device to perform the method of one or more of Aspects 1-56.

Aspect 63: An apparatus for wireless communication at a device, the apparatus comprising one or more memories and one or more processors coupled to the one or more memories, the one or more processors individually or collectively configured to cause the device to perform the method of one or more of Aspects 1-56.

The foregoing disclosure provides illustration and description but is not intended to be exhaustive or to limit the aspects to the precise forms disclosed. Modifications and variations may be made in light of the above disclosure or may be acquired from practice of the aspects. No element, act, or instruction described herein should be construed as critical or essential unless explicitly described as such.

It will be apparent that systems or methods described herein may be implemented in different forms of hardware or a combination of hardware and software. The actual specialized control hardware or software used to implement these systems or methods is not limiting of the aspects. Thus, the operation and behavior of the systems or methods are described herein without reference to specific software code, because those skilled in the art will understand that software and hardware can be designed to implement the systems or methods based, at least in part, on the description herein. A component being configured to perform a function means that the component has a capability to perform the function, and does not require the function to be actually performed by the component, unless noted otherwise.

As used herein, the articles “a” and “an” are intended to refer to one or more items and may be used interchangeably with “one or more” or “at least one.” Further, as used herein, the article “the” is intended to include one or more items referenced in connection with the article “the” and may be used interchangeably with “the one or more.” Furthermore, as used herein, the terms “set” and “group” are intended to include one or more items and may be used interchangeably with “one or more.” Where only one item is intended, the phrase “only one” or “a single one” or similar language is used. Also, as used herein, the terms “has,” “have,” “having,” “comprise,” “comprising,” “include” and “including,” and derivatives thereof or similar terms are intended to be open-ended terms that do not limit an element that they modify (in some aspects, an element “having” A may also have B). Also, as used herein, the term “or” is intended to be inclusive when used in a series and may be used interchangeably with “and/or,” unless explicitly stated otherwise (in some aspects, if used in combination with “either” or “only one of”). As used herein, a phrase referring to “at least one of” a list of items refers to any combination of those items, including single members. As an example, “at least one of: a, b, or c” is intended to cover a, b, c, a+b, a+c, b+c, and a+b+c, as well as any combination with multiples of the same element (in some aspects, a+a, a+a+a, a+a+b, a+a+c, a+b+b, a+c+c, b+b, b+b+b, b+b+c, c+c, and c+c+c, or any other ordering of a, b, and c).

As used herein, the term “determine” or “determining” encompasses a wide variety of actions and, therefore, “determining” can include calculating, computing, processing, deriving, estimating, investigating, looking up (such as via looking up in a table, a database, or another data structure), searching, inferring, ascertaining, and/or measuring, among other possibilities. Also, “determining” can include receiving (such as receiving information), accessing (such as accessing data stored in memory) or transmitting (such as transmitting information), among other possibilities. Additionally, “determining” can include resolving, selecting, obtaining, choosing, establishing, and/or other such similar actions.

As used herein, the phrase “based on” is intended to mean “based at least in part on” or “based on or otherwise in association with” unless explicitly stated otherwise. As used herein, “satisfying a threshold” may, depending on the context, refer to a value being greater than the threshold, greater than or equal to the threshold, less than the threshold, less than or equal to the threshold, equal to the threshold, or not equal to the threshold, among other examples.

Even though particular combinations of features are recited in the claims or disclosed in the specification, these combinations are not intended to limit the scope of all aspects described herein. Many of these features may be combined in ways not specifically recited in the claims or disclosed in the specification. The disclosure of various aspects includes each dependent claim in combination with every other claim in the claim set.

What is claimed is:

1. An apparatus for wireless communication at a user equipment (UE), comprising:
one or more memories; and
one or more processors, coupled to the one or more memories, individually or collectively configured to:
receive, from a network node via a first random access message as part of a random access procedure, an uplink resource grant associated with a first set of capabilities, wherein the UE is associated with a second set of capabilities; and
transmit, via a modified uplink resource grant, a second random access message in accordance with identifying that the uplink resource grant is incompatible with the second set of capabilities.

2. The apparatus of claim 1, wherein the one or more processors are individually or collectively configured to:
receive an indication that enables the UE to modify the uplink resource grant to include one or more frequency hops that overlap in a frequency domain with a set of frequency resources indicated by the uplink resource grant, wherein transmitting the second random access message comprises:
transmit, via the one or more frequency hops, the second random access message, wherein the set of frequency resources indicated by the uplink resource grant is different from a set of frequency resources associated with the UE.

3. The apparatus of claim 1, wherein the one or more processors are individually or collectively configured to:
transmit a third random access message via a first set of frequency resources associated with the UE, wherein transmitting the second random access message comprises:
transmit the second random access message via a second set of frequency resources, indicated by the uplink resource grant, in association with switching from communicating via the first set of frequency resources to communicating using the second set of frequency resources, wherein the second set of frequency resources is a subset of the first set of frequency resources.

4. The apparatus of claim 3, wherein the modified uplink resource grant includes the second set of frequency resources in association with the UE being associated with the second set of capabilities.

5. The apparatus of claim 1, wherein the one or more processors are individually or collectively configured to:
refrain from transmitting the second random access message via the set of frequency resources indicated by the uplink resource grant.

6. The apparatus of claim 1, wherein the one or more processors are individually or collectively configured to:
receive an indication that enables the UE to modify the uplink resource grant to omit one or more time resources, including a first-occurring time resource, indicated by the uplink resource grant to obtain a subset of time resources, wherein a time offset between the first random access message and the first-occurring time resource is less than a time offset for the UE to switch from communicating via a first frequency range to a second frequency range.

7. The apparatus of claim 6, wherein one or more reference signals are scheduled for transmission via at least one time resource subsequent to the first-occurring time resource in association with omitting the one or more time resources.

8. The apparatus of claim 6, wherein the one or more processors are individually or collectively configured to:
rate-matching the second random access message via the modified uplink resource grant that includes the subset of time resources in association with omitting the one or more time resources.

9. The apparatus of claim 1, wherein the one or more processors are individually or collectively configured to:
receive an indication that enables the UE to modify the uplink resource grant to omit one or more time resources associated with at least one of a first frequency hop or a second frequency hop, wherein a time offset between the first frequency hop and the second frequency hops is less than a retuning gap associated with the UE, wherein transmitting the second random access message comprises:
transmit the second random access message via the modified uplink resource grant including one or more of a set of time resources associated with the first frequency hop, a set of time resources associated with the second frequency hop, a subset of time resources associated with the first frequency hop, or a subset of resources associated with the second frequency hop.

10. A method of wireless communication performed by a user equipment (UE), comprising:
receiving, from a network node via a first random access message as part of a random access procedure, an uplink resource grant associated with a first set of capabilities, wherein the UE is associated with a second set of capabilities; and
transmitting, via a modified uplink resource grant, a second random access message in accordance with identifying that the uplink resource grant is incompatible with the second set of capabilities.

11. The method of claim 10, wherein transmitting the second random access message comprises:
transmitting the second random access message including an indication of the second set of capabilities, wherein the modified uplink resource grant at least partially overlaps in at least one of time or frequency with a resource grant for communications at an additional UE that is associated with the first set of capabilities.

12. The method of claim 11, wherein the indication comprises a special access identifier.

13. The method of claim 11, wherein the indication comprises at least one of:
an interleaving pattern associated with the second set of capabilities,
a scrambling pattern associated with the second set of capabilities,
a cyclic redundancy check algorithm associated with the second set of capabilities, or
a demodulation reference scheme associated with the second set of capabilities.

14. The method of claim 11, further comprising:
receiving a message including a set of patterns for indicating the second set of capabilities, wherein the message includes system information.

15. The method of claim 11, wherein the uplink resource grant includes a set of patterns for indicating the second set of capabilities.

16. The method of claim 10, wherein the second random access message includes at least one of:
an initial uplink data channel message, or
a retransmitted uplink data channel message.

17. The method of claim 10, wherein:
the random access procedure includes a four-step random access procedure and the first random access message includes a msg2, or
the random access procedure includes a two-step random access procedure and the first random access message includes a fallback random access response message.

18. The method of claim 10, further comprising:
receiving an indication that enables the UE to modify the uplink resource grant to include frequency resources indicated by the uplink resource grant that overlap in a frequency domain with a set of frequency resources associated with the UE; and
puncturing the second random access message via the modified uplink resource grant that includes a subset of frequency resources indicated by the uplink resource grant, wherein the set of frequency resources associated with the UE includes the subset of frequency resources.

19. The method of claim 10, further comprising:
receiving an indication that enables the UE to modify the uplink resource grant to include frequency resources indicated by the uplink resource grant that overlap with a set of frequency resources associated with the UE; and
rate-matching the second random access message via the modified uplink resource grant that includes a subset of frequency resources indicated by the uplink resource grant, wherein the set of frequency resources associated with the UE includes the subset of frequency resources.

20. A non-transitory computer-readable medium storing a set of instructions for wireless communication, the set of instructions comprising:
one or more instructions that, when executed by one or more processors of a user equipment (UE), cause the UE to:
receive, from a network node via a first random access message as part of a random access procedure, an uplink resource grant associated with a first set of capabilities, wherein the UE is associated with a second set of capabilities; and
transmit, via a modified uplink resource grant, a second random access message in accordance with identifying that the uplink resource grant is incompatible with the second set of capabilities.

21. The non-transitory computer-readable medium of claim 20, wherein the one or more instructions further cause the UE to:
initiate an additional random access procedure in association with identifying that transmitting the second random access message via the modified uplink resource grant failed.

22. The non-transitory computer-readable medium of claim 20, wherein the one or more instructions further cause the UE to:
modify the uplink resource grant to obtain the modified uplink resource grant in association with the second random access message including a msg3 of the random access procedure.

23. The non-transitory computer-readable medium of claim 20, wherein the one or more instructions further cause the UE to:
receive an indication that the network node supports initial access communications with the UE according to the second set of capabilities.

24. The non-transitory computer-readable medium of claim 20, wherein the second set of capabilities includes a reduced set of capabilities with respect to the first set of capabilities.

25. The non-transitory computer-readable medium of claim 20, wherein the second set of capabilities includes one or more of:
a reduced bandwidth capability,
a reduced latency capability, or
a half-duplex communications capability.

26. The non-transitory computer-readable medium of claim 20, wherein the first set of capabilities includes one or more of:
a bandwidth capability,
a latency capability,
a full-duplex communication capability.

27. An apparatus for wireless communication, comprising:
means for receiving, from a network node via a first random access message as part of a random access procedure, an uplink resource grant associated with a first set of capabilities, wherein the apparatus is associated with a second set of capabilities; and
means for transmitting, via a modified uplink resource grant, a second random access message in accordance with identifying that the uplink resource grant is incompatible with the second set of capabilities.

28. The apparatus of claim 27, further comprising:
means for receiving signaling indicating a set of time-frequency resources for which the random access procedure is enabled for the apparatus in association with the apparatus being associated with the second set of capabilities.

29. The apparatus of claim 28, wherein the signaling includes one or more of:
synchronization signal block signaling,
system information block signaling,
radio resource control signaling, or
medium access control control element signaling.

30. The apparatus of claim 27, wherein the apparatus is associated with one or more of:
an idle radio resource control state, or
an inactive radio resource control state.
